(19) United States
(12) Patent Application Publication
(10) Pub. No.: US 2014/0312523 A1
(43) Pub. Date: Oct. 23, 2014

(54) THICK RARE EARTH MAGNET FILM AND LOW-TEMPERATURE SOLIDIFYING AND MOLDING METHOD

(71) Applicant: NISSAN MOTOR CO., LTD., Kanagawa (JP)

(72) Inventors: Yoshio Kawashita, Kamakura-shi (JP); Kazuhiko Takashima, Yokohama-shi (JP); Toshikazu Nanbu, Machida-shi (JP)

(21) Appl. No.: 14/362,834

(22) PCT Filed: Oct. 22, 2012
(86) PCT No.: PCT/JP2012/077257

§ 371 Date: Jun. 4, 2014

(30) Foreign Application Priority Data
Dec. 6, 2011 (JP) 2011-267140

(51) Int. Cl. H01F 1/01; H01F 41/16

(52) U.S. Cl. CPC H01F 1/01; H01F 41/16
USPC 264/134; 428/546; 252/62.55

(57) ABSTRACT

A thick magnet film contains a rare earth magnet phase represented by formula R-M-X, where R contains at least one of Nd and Sm, M contains at least one of Fe and Co, and X contains at least one of N and B. The thick magnet film has a density of equal to or more than 80% but less than 95% of the theoretical density when R contains Nd as a main component and has the density of equal to or more than 80% but less than 97% of the theoretical density when R contains Sm as a main component. The magnet can achieve an increase in thickness when formed into a film, an increase in density and an improvement in magnetic properties such as residual magnetic flux density.

### CROSS REFERENCE TO RELATED APPLICATION

The present application claims priority to Japanese Patent Application No. 2011-267140, filed Dec. 6, 2011, incorporated herein in its entirety.

### TECHNICAL FIELD

The present invention relates to a thick rare earth magnet film and a low-temperature solidifying and molding method.

### BACKGROUND

There are two major types of a rare earth magnet that are currently used, that is, a sintered magnet and a bond magnet. The bond magnet is used after solidifying and molding of a raw magnetic material powder having excellent magnetic properties at room temperature.

The difference of a bond magnet compared to a sintered magnet is, the raw magnetic material powder has magnetic properties in case of a bond magnet, but in case of a sintered magnet, the magnetic properties of raw magnetic material powder are insufficient because excellent magnetic properties can be exhibited only by heating at high temperature enough to yield a liquid phase. The raw material powder for a bond magnet has a problem that, when heated at high temperature, the magnetic properties are deteriorated.

As for the reason for deteriorated magnetic properties, the properties are lost as the magnet compound is decomposed at high temperature such as SmFeN magnet. Like NdFeB magnet, magnetic powder having excellent magnetic properties due to refined particle grains turn into have coarse particle grains by heating, deteriorating the excellent magnetic properties, for example.

Thus, like a common sintered magnet, the process for solidifying and molding which is accompanied with grain boundary modification or a change in structure by heating at 1000° C. or so has a problem that a bulk molded product cannot be obtained.

Accordingly, for the raw magnetic material powder, injection molding or a method of bulking with frame molding a slurry kneaded with a resin is used as a technique of solidifying and molding at room temperature or relatively low temperature. However, according to those methods, there is a problem that resins are inevitably present to lower a net component of magnet.

In this regard, as a method of obtaining a bulk molded product having high density, there is a method of solidifying and molding by depositing a raw magnet material powder on a substrate. For example, in Journal of the Institute of Electrical Engineers of Japan A, Vol. 124 (2004), No. 10 pp. 887-891, a method of spraying in vacuum a raw magnet material powder prepared as aerosol on a substrate is tested (aerosol deposition method; AD method).

However, according to the method described in Journal of the Institute of Electrical Engineers of Japan A, Vol. 124 (2004), No. 10 pp. 887-891, although higher density is obtained compared to a bond magnet, gas flow rate is slower than cold spray in principle, and thus there are problems that adhesiveness between particles is low then a bulk molded product with sufficiently high density is not necessarily obtained. There are also problems that, as gas flow rate is slow, a big particle or a heavy particle as a raw material powder to be used cannot be accelerated, and as the film forming speed is slow, a film thicker than 500 μm (measured value is 175 μm), which is possible for film forming, cannot be obtained.

### BRIEF SUMMARY

Accordingly, an object of the present invention is to provide a magnet which can satisfy all of the increase in a film thickness, the increase in density, and the improvement in magnetic properties (residual magnetic flux density and hardness, in particular), and a method for producing it.

The present invention relates to a thick magnet film characterized by containing a rare earth magnet phase represented by the formula (1): R-M-X, in which it has the density of equal to or higher than 80% but less than 95% of the theoretical density when R═Nd as a main component, and has the density of equal to or more than 80% but less than 97% of the theoretical density when R═Sm as a main component. Herein, R contains at least one of Nd and Sm, M contains at least one of Fe and Co, and X contains at least one of N and B (the same shall apply herein below).

### BRIEF DESCRIPTION OF THE DRAWINGS

FIG. 1 is a schematic drawing diagrammatically illustrating the constitution of an apparatus used for cold spray method, which is a representative method for forming powder film in which the film is formed by depositing particles, as used for the method for producing a thick magnet film of the present invention.

FIGS. 2A-2C illustrate an overview of the magnet film formed on a center part of the surface of a substrate when the gas pressure for the process for forming powder film in which the film is formed by depositing particles (cold spray method), as used for the method for producing a thick magnet film of the present invention, is changed to 0.4 MPa, 0.6 MPa, or 0.8 MPa, respectively.

FIG. 3 is a graph illustrating the relation between the residual magnetization and density that are exhibited by thick magnet films of Examples 1 to 9 and Comparative Examples 2 and 4 and those exhibited by the AD method of a related art (Journal of the Institute of Electrical Engineers of Japan A, Vol. 124 (2004), No. 10 pp. 887-891). Meanwhile, the literature values given in the drawing are the values (two points) exhibited by the AD method of a related art (Journal of the Institute of Electrical Engineers of Japan A, Vol. 124 (2004), No. 10 pp. 887-891). As no magnet film (thick magnet film) is obtained from Comparative Examples 1 and 3, the residual magnetization (residual magnetic flux density) and density cannot be measured, and therefore cannot be exhibited.

FIG. 4 is a graph illustrating the relation between the hardness (Hv) and density that are exhibited by thick magnet films of Examples 1 to 9 and Comparative Examples 2 and 4 and those exhibited by the AD method of a related art (Journal of the Institute of Electrical Engineers of Japan A, Vol. 124 (2004), No. 10 pp. 887-891). Meanwhile, the literature values given in the drawing are the values (two points) exhibited by the AD method of a related art (Journal of the Institute of Electrical Engineers of Japan A, Vol. 124 (2004), No. 10 pp. 887-891). As no magnet film (thick magnet film) is obtained from Comparative Examples 1 and 3, the residual magnetization (residual magnetic flux density) and density cannot be measured, and therefore cannot be exhibited.

FIG. 5A is a schematic cross-sectional view illustrating diagrammatically the rotor structure of a surface permanent magnet synchronous motor (SMP or SPMSM).

FIG. 5B is a schematic cross-sectional view illustrating diagrammatically the rotor structure of an interior permanent magnet synchronous motor (IMP or IPMSM).

### DETAILED DESCRIPTION OF EMBODIMENTS

Herein below, the embodiments of the present invention are explained with reference to the attached drawings. Meanwhile, for explanation of the drawings, the same element is given with the same symbol and overlapped explanations are omitted. The size ratio in the drawing can be exaggerated for convenience, and it may be different from the actual ratio.

### (A) Thick Magnet Film (First Embodiment)

The first embodiment of the present invention contains a rare earth magnet phase represented by the formula (1): R-M-X. It is characterized in that, when R is Nd as a main component, it has the density of equal to or more than 80% but less than 95% of the theoretical density, and when R is Sm as a main component, it has the density of equal to or more than 80% but less than 97% of the theoretical density. Herein, R contains at least one of Nd and Sm, M contains at least one of Fe and Co, and X contains at least one of N and B in the aforementioned compositional formula. By having the thick magnet film constitution of the first embodiment, the net magnet content is increased and a small-sized but strong magnet is obtained, enabling miniaturization of a system such as motor. Magnet powder, which has been used by solidifying and molding of a resin in a related art for a bond magnet, can be molded by solidification at high density, and thus it can contribute to miniaturization and achievement of high performance of a motor. Hereinbelow, constitution of the thick magnet film and the production method (second embodiment) are explained in order.

(1) Formula (1); Rare Earth Magnet Phase Represented by R-M-X

The thick magnet film of the present invention contains a rare earth magnet phase represented by the formula (1): R-M-X. It is characterized in that, when R is Nd as a main component, it has the density of equal to or more than 80% but less than 95% of the theoretical density, and when R is Sm as a main component, it has the density of equal to or more than 80% but less than 97% of the theoretical density. Herein, R contains at least one of Nd and Sm, M contains at least one of Fe and Co, and X contains at least one of N and B in the aforementioned compositional formula of the rare earth magnet phase. Specifically, examples of the rare earth magnet phase include those containing Nd—Fe—N alloy base, Nd—Fe—B alloy base, Nd—Co—N alloy base, Nd—Co—B alloy base, Sm—Fe—N alloy base, Sm—Fe—B alloy base, Sm—Co—N alloy base, or Sm—Co—B alloy base. Specific examples thereof include a compound such as Nd₂Fe₁₄B, Nd₂Co₁₄B, Nd₂(Fe₁₋ₓCoₓ)₁₄B (in the formula, x is preferably such that 0≦x≦0.5), Nd₁₅Fe₇₇B₅, Nd₁₅Co₇₇B₅, Nd_{11.77}Fe_{82.35}B_{5.88}, Nd_{11.77}Co_{82.35}B_{5.88}, Nd_{1.1}Fe₄B₄, Nd_{1.1}Co₄B₄, Nd₇Fe₃B₁₀, Nd₇Co₃B₁₀, (Nd₁₋ₓDyₓ)₁₅Fe₇₇B₈ (in the formula, x is preferably such that 0≦y≦0.4), (Nd₁₋ₓDyₓ)₁₅Co₇₇B₈ (in the formula, x is preferably such that 0≦y≦0.4), Nd₂Fe₁₇Nₓ (in the formula, x is preferably 1 to 6, more preferably 1.1 to 5, even more preferably 1.2 to 3.8, and particularly preferably 1.7 to 3.3, and among them, it is 2.2 to 3.1), Nd₂Co₁₇Nₓ (in the formula, x is preferably 1 to 6), (Nd_{0.75}Zr_{0.25})(Fe_{0.7}Co_{0.3})Nₓ (in the formula, x is preferably 1 to 6), Nd₂Fe₁₇N₃, Nd₁₅(Fe₁₋ₓCoₓ)₇₇B₇Al₁, Nd₁₅(Fe_{0.80}Co_{0.20})_{77-y}B₈Al_{y} (in the formula, y is preferably such that 0≦y≦5), (Nd_{0.95}Dy_{0.05})₁₅Fe_{77.5}B₇Al_{0.5}, (Nd_{0.95}Dy_{0.05})₁₅(Fe_{0.95}Co_{0.05})_{77.5}B_{6.5}Al_{0.5}Cu_{0.2}, NdFe₁₁TiNₓ (in the formula, x is preferably 1 to 6), (Nd₈Zr₃Fe₈₄)₈₅N₁₅, Nd₄Fe₈₀B₂₀, Nd_{4.5}Fe₇₃Co₃GaB_{18.5}, Nd_{5.5}Fe₆₆Cr₅Co₅B_{18.5}, Nd₁₀Fe₇₄Co₁₀SiB₅, Nd₇Fe₉₃Nₓ (in the formula, x is preferably 1 to 20), Nd_{3.5}Fe₇₈B_{18.5}, Nd₄Fe_{76.5}B_{18.5}, Nd₄Fe_{77.5}B_{18.5}, Nd_{4.5}Fe₇₇B_{18.5}, Nd_{3.5}DyFe₇₃Co₃GaB_{18.5}, Nd_{4.5}Fe₇₂Cr₂Co₃B_{18.5}, Nd_{4.5}Fe₇₃V₃SiB_{18.5}, Nd_{4.5}Fe₇₁Cr₃Co₃B_{18.5}, Nd_{5.5}Fe₆₆Cr₅Co₅B_{18.5}, Sm₂Fe₁₄B, Sm₂Co₁₄B, Sm₂(Fe₁₋ₓCoₓ)₁₄B (in the formula, x is preferably such that 0≦x≦0.5), Sm₁₅Fe₇₇B₅, Sm₁₅Co₇₇B₅, Sm_{11.77}Fe_{82.35}B_{5.88}, Sm_{11.77}Co_{82.35}B_{5.88}, Sm_{1.1}Fe₄B₄, Sm_{1.1}Co₄B₄, Sm₇Fe₃B₁₀, Sm₇Co₃B₁₀, (Sm₁₋ₓDyₓ)₁₅Fe₇₇B₈ (in the formula, x is preferably such that 0≦y≦0.4), (Sm₁₋ₓDyₓ)₁₅Co₇₇B₈ (in the formula, x is preferably such that 0≦y≦0.4), Sm₂Fe₁₇Nₓ (in the formula, x is preferably 1 to 6, more preferably 1.1 to 5, even more preferably 1.2 to 3.8, and particularly preferably 1.7 to 3.3, and among them, 2.2 to 3.1), Sm₂Fe₁₇N₃, Sm₂Co₁₇Nₓ (in the formula, x is preferably 1 to 6), (Sm_{0.75}Zr_{0.25})(Fe_{0.7}Co_{0.3})Nₓ (in the formula, x is preferably 1 to 6), Sm₁₅(Fe₁₋ₓCoₓ)₇₇B₇Al₁, Sm₁₅(Fe_{0.80}Co_{0.20})_{77-y}B₈Al_{y} (in the formula, y is preferably such that 0≦y≦5), (Sm_{0.95}Dy_{0.05})₁₅Fe_{77.5}B₇Al_{0.5}, (Sm_{0.95}Dy_{0.05})₁₅(Fe_{0.95}Cu_{0.05})_{77.5}B_{6.5}Al_{0.5}Cu_{0.2}, SmFe₁₁TiNₓ (in the formula, x is preferably 1 to 6), (Sm₈Zr₃Fe₈₄)₈₅N₁₅, Sm₄Fe₈₀B₂₀, Sm_{4.5}Fe₇₃Co₃GaB_{18.5}, Sm_{5.5}Fe₆₆Cr₅Co₅B_{18.5}, Sm₁₀Fe₇₄Co₁₀SiB₅, Sm₇Fe₉₃Nₓ (in the formula, x is preferably 1 to 20), Sm_{3.5}Fe₇₈B_{18.5}, Sm₄Fe_{76.5}B_{18.5}, Sm₄Fe_{77.5}B_{18.5}, Sm_{4.5}Fe₇₇B_{18.5}, Sm_{3.5}DyFe₇₃Co₃GaB_{18.5}, Sm_{4.5}Fe₇₂Cr₂Co₃B_{18.5}, Sm_{4.5}Fe₇₃V₃SiB_{18.5}, Sm_{4.5}Fe₇₁Cr₃Co₃B_{18.5}, or Sm_{5.5}Fe₆₆Cr₅Co₅B_{18.5}, but not limited thereto. The R-M-X alloy base may be used either singly or in combination of two or more types to form a thick magnet film.

It is also possible to form a thick magnet film with a multi-layer structure that is obtained by laminating rare earth magnet phases of different composition by using the R-M-X alloy base of different kind for each layer. Even for such a case, the R-M-X alloy base may be used either singly or in combination of two or more types for each layer. In the R-M-X alloy base, it is sufficient that R contains at least one of Nd and Sm, M contains at least one of Fe and Co, and X contains at least one of N and B, and those added with other element are also within the technical scope of the present invention (see, Examples 7 to 9). Examples of other element which can be added include Ga, Al, Zr, Ti, Cr, V, Mo, W, Si, Re, Cu, Zn, Ca, Mn, Ni, C, La, Ce, Pr, Pm, Eu, Gd, Tb, Dy, Ho, Er, Tm, Yb, Lu, Y, Th, and MM (MM is a mixture of light rare earth elements, referred to as mischmetal), but not limited thereto. They may be added either singly or in combination of two or more types. Those elements are introduced mainly by substitution with a part of the phase structure of the rare earth magnet phase represented by R-M-X, or by insertion into it.

(2) Rare Earth Magnet Phase Having Sm—Fe—N as Main Component

The rare earth magnet phase of the present embodiment is preferably the one having as a main component a nitrogen compound containing Sm and Fe (simply referred to as Sm—Fe—N), and more preferably magnet powder having a nitrogen compound containing Sm and Fe as a main component. Accordingly, a thick magnet film of high density nitrogen compound (with equal to or more than 80% but less than 97%, in particular equal to or more than 85% but less than 97% of theoretical density) that is not obtainable by a process of a related art can be obtained, and it is excellent from the viewpoint of enabling miniaturization of a system such as motor. Examples of the rare earth magnet phase having, as a main component, a nitrogen compound containing Sm and Fe include a compound such as Sm₂Fe₁₇Nₓ (in the formula, x is preferably 1 to 6, more preferably 1.1 to 5, even more preferably 1.2 to 3.8, even still more preferably 1.7 to 3.3, and particularly preferably 2.2 to 3.1, and among them, preferably 2 to 3, and most preferably 2.6 to 2.8), Sm₂Fe₁₇N₃, (Sm_{0.75}Zr_{0.25})(Fe_{0.7}Co_{0.3})Nₓ (in the formula, x is preferably 1 to 6), SmFe₁₁TiNₓ (in the formula, x is preferably 1 to 6), (Sm₈Zr₃Fe₈₄)₈₅N₁₅, or Sm₇Fe₉₃Nₓ (in the formula, x is preferably 1 to 20), but not limited thereto. Preferably, as for the raw magnet material powder used in the present embodiment, magnet powder such as Sm₂Fe₁₄Nₓ (x=2 to 3) for which a sintering process is hardly applicable is desirably used. That is because, when the carrier gas temperature is higher than the temperature at which the nitrogen compound (nitride) is decomposed, the magnetic properties are deteriorated. As for the raw magnet material powder used in the present embodiment, it is more preferable to use magnet powder of Sm₂Fe₁₄Nₓ (x=2.6 to 2.9), particularly preferably Sm₂Fe₁₄Nₓ (x=2.6 to 2.8), and among them, preferably Sm₂Fe₁₄Nₓ (x=2.8). The reason is that, when x=2.6 to 2.9, particularly 2.6 to 2.8, and among them, 2.8 in SmFeNₓ, the anisotropic magnet field and saturated magnetization reach their maximum to yield excellent magnetic properties. The Sm—Fe—N alloy base may be used either singly or in combination of two or more types to form a thick magnet film.

It is also possible to form a thick magnet film with a multi-layer structure that is obtained by laminating rare earth magnet phases of different composition by using the Sm—Fe—N alloy base of different kind for each layer. Even for such a case, the Sm—Fe—N alloy base may be used either singly or in combination of two or more types for each layer. Further, in the compound represented by the Sm—Fe—N alloy base as exemplified above, it is sufficient that R contains Sm, M contains Fe, and X contains N, and those added with other element are also within the technical scope of the present embodiment. Examples of other element which can be added include Ga, Nd, Al, Zr, Ti, Cr, Co, V, Mo, W, Si, Re, Cu, Zn, Ca, B, Mn, Ni, C, La, Ce, Pr, Pm, Eu, Gd, Tb, Dy, Ho, Er, Tm, Yb, Lu, Y, Th, and MM, but not limited thereto. They may be added either singly or in combination of two or more types. Those elements are introduced mainly by substitution of a part of the phase structure of a rare earth magnet phase represented by Sm—Fe—N, or by insertion into it. It is sufficient for the thick magnet film of the present embodiment to contain a rare earth magnet phase represented by R-M-X described above, and within a range that does not inhibit the working effect of the present embodiment, it may contain other rare earth magnet phase. Examples of the other rare earth magnet phase include other existing rare earth magnet phase other than the aforementioned R-M-X alloy base, excluding the nitrogen compound containing Sm and Fe (Sm—Fe—N alloy base).

Examples of other existing rare earth magnet phase include Sm—Co alloy base such as SmCo₅, Sm₂Co₁₇, Sm₃Co, Sm₃Co₉, SmCo₂, SmCo₃, or Sm₂Co₇, Sm—Fe alloy base such as Sm₂Fe₁₇, SmFe₂, or SmFe₃, Ce—Co alloy base such as CeCo₅, Ce₂Co₁₇, Ce₂₄Co₁₁, CeCo₂, CeCo₃, Ce₂Co₇, or Ce₅Co₁₉, Nd—Fe alloy base such as Nd₂Fe₁₇, Ca—Cu alloy base such as CaCu₅, Tb—Cu alloy base such as TbCu₇, Sm—Fe—Ti alloy base such as SmFeₙ Ti, Th—Mn alloy base such as ThMn₁₂, Th—Zn alloy base such as Th₂Zn₁₇, Th—Ni alloy base such as Th₂Ni₁₇, La₂Fe₁₄B, CeFe₁₄B, Pr₂Fe₁₄B, Gd₂Fe₁₄B, Tb₂Fe₁₄B, Dy₂Fe₁₄B, Ho₂Fe₁₄B, Er₂Fe₁₄B, Tm₂Fe₁₄B, Yb₂Fe₁₄B, Y₂Fe₁₄B, Th₂Fe₁₄B, La₂Co₁₄B, CeCo₁₄B, Pr₂Co₁₄B, Gd₂Co₁₄B, Tb₂Co₁₄B, Dy₂Co₁₄B, Ho₂Co₁₄B, Er₂Co₁₄B, Tm₂Co₁₄B, Yb₂Co₁₄B, Y₂Co₁₄B, Th₂Co₁₄B, YCo₅, LaCo₅, PrCo₅, NdCo₅, GdCo₅, TbCo₅, DyCo₅, HoCo₅, ErCo₅, TmCo₅, MMCo₅, MM_{0.8}Sm_{0.2}Co₅, Sm_{0.6}Gd_{0.4}Co₅, YFe₁₁Ti, NdFe₁₁Ti, GdFe₁₁Ti, TbFe₁₁Ti, DyFe₁₁Ti, HoFe₁₁Ti, ErFe₁₁Ti, TmFe₁₁Ti, LuFe₁₁Ti, Pr_{0.6}Sm_{0.4}Co, Sm_{0.6}Gd_{0.4}Co₅, Ce(Co_{0.72}Fe_{0.14}Cu_{0.14})_{5.2}, Ce(Co_{0.73}Fe_{0.12}Cu_{0.14}Ti_{0.01})_{6.5}, (Sm_{0.7}Ce_{0.3})(Co_{0.72}Fe_{0.16}Cu_{0.12})₇, Sm(Co_{0.69}Fe_{0.20}Cu_{0.10}Zr_{0.01})_{7.4}, and Sm(Co_{0.65}Fe_{0.21}Cu_{0.05}Zr_{0.02})_{7.67}, but not limited thereto. It may be used either singly or in combination of two or more types.

(2a) Content of Main Component (Sm—Fe—N)

The rare earth magnet phase of the present embodiment is preferably the one having as a main component a nitrogen compound containing Sm and Fe (Sm—Fe—N alloy base), and the nitrogen compound containing Sm and Fe is 50% by mass or more, preferably 80% by mass or more, more preferably 90% by mass or more, and even more preferably 90 to 99% by mass with respect to the entire rare earth magnet phase. Meanwhile, the upper limit of the range is more preferably 99% by mass but not 100% by mass, because oxide on the surface or unavoidable impurities are included. In other words, in the present embodiment, it is sufficient to have 50% by mass or more, and although it is possible to use the one of 100% by mass, it is practically difficult to remove oxide on the surface or unavoidable impurities and a complex and sophisticated purifying (refining) technique is required, and thus it is expensive. For such reasons, it is not included in the more preferred range. Even when R-M-X (for example, Nd—Fe—B) other than Sm—Fe—N alloy base is used as a main component, it is preferable that the other R-M-X is used at 50% by mass or more, preferably at 80% by mass or more, more preferably 90% by mass or more, and even more preferably at 90 to 99% by mass with respect to the entire rare earth magnet phase.

(2b) Rare Earth Magnet Phase Other than Main Component (Sm—Fe—N)

As other rare earth magnet phase, not only the aforementioned Nd—Fe—N alloy base, Nd—Fe—B alloy base, Nd—Co—N alloy base, Nd—Co—B alloy base, Sm—Fe—B alloy base, Sm—Co—N alloy base, or Sm—Co—B alloy base other than the nitrogen compound containing Sm and Fe (Sm—Fe—N alloy base) but also other existing rare earth magnet phase can be used. Examples of the other existing rare earth magnet phase include Sm—Co alloy base such as SmCo₅, Sm₂Co₁₇, Sm₃Co, Sm₃Co₉, SmCo₂, SmCo₃, or Sm₂Co₇, Sm—Fe alloy base such as Sm₂Fe₁₇, SmFe₂, or SmFe₃, Ce—Co alloy base such as CeCo₅, Ce₂Co₁₇, Ce₂₄Co₁₁, CeCo₂, CeCo₃, Ce₂Co₇, or Ce₅Co₁₉, Nd—Fe alloy base such as Nd₂Fe₁₇, Ca—Cu alloy base such as CaCu₅, Tb—Cu alloy base such as TbCu⁷, Sm—Fe—Ti alloy base such as SmFe₁₁Ti, Th—Mn alloy base such as ThMn₁₂, Th—Zn alloy base such as Th₂Zn₁₇, Th—Ni alloy base such as Th₂Ni₁₇, La₂Fe₁₄B, CeFe₁₄B, Pr₂Fe₁₄B, Gd₂Fe₁₄B, Tb₂Fe₁₄B, Dy₂Fe₁₄B, Ho₂Fe₁₄B, Er₂Fe₁₄B, Tm₂Fe₁₄B, Yb₂Fe₁₄B, Y₂Fe₁₄B, Th₂Fe₁₄B, La₂Co₁₄B, CeCo₁₄B, Pr₂Co₁₄B, Gd₂Co₁₄B, Tb₂Co₁₄B, Dy₂Co₁₄B, Ho₂Co₁₄B, Er₂Co₁₄B, Tm₂Co₁₄B, Yb₂Co₁₄B, Y₂Co₁₄B, Th₂Co₁₄B, YCo₅, LaCo₅, PrCo₅, NdCo₅, GdCo₅, TbCo₅, DyCo₅, HoCo₅, ErCo₅, TmCo₅, MMCo₅, MM_{0.85}Sm_{0.2}Co₅, Sm_{0.6}Gd_{0.4}Co₅, YFe₁₁Ti, NdFe₁₁Ti, GdFe₁₁Ti, TbFe₁₁Ti, DyFe₁₁Ti, HoFe₁₁Ti, ErFe₁₁Ti, TmFe₁₁Ti, LuFe₁₁Ti, Pr_{0.6}Sm_{0.4}Co, Sm_{0.6}Gd_{0.4}Co₅, Ce(Co_{0.72}Fe_{0.14}Cu_{0.14})_{5.2}, Ce(Co_{0.73}Fe_{0.12}Cu_{0.14}Ti_{0.01})_{6.5}, (Sm_{0.7}Ce_{0.3})(Co_{0.72}Fe_{0.16}Cu_{0.12})₇, Sm(Co_{0.69}Fe_{0.20}Cu_{0.10}Zr_{0.01})_{7.4}, and Sm(Cu_{0.65}Fe_{0.21}Cu_{0.05}Zr_{0.02})_{7.67}, but not limited thereto. It may be used either singly or in combination of two or more types.

(2c) with Regard to Magnet Powder

(2c-1) Shape of Magnet Powder

Shape of the magnet powder containing the rare earth magnet phase of the present embodiment (shape of the magnet powder having as a main component a nitrogen compound containing Sm and Fe that is particularly preferable) can be any shape if it is within the range that does not inhibit the working effect of the present invention. Examples thereof include spherical shape, elliptical shape (length/width ratio (aspect ratio) of a cross-section of a center part parallel to the direction of long axis is desirably higher than 1.0 but less than or equal to 10), cylindrical shape, polygonal shape (for example, trigonal prism, tetragonal prism, pentagonal prism, hexagonal prism, . . . , prism with N polyhedral prism (in which N is an integer of 7 or more)), needle shape or rod shape (length/width ratio (aspect ratio) of a cross-section of a center part parallel to the direction of long axis is desirably higher than 1.0 but less than or equal to 10), plate shape, circular plate (disc) shape, thin piece, flake shape, and amorphous shape, but not limited thereto. In other words, particle shape is not particularly limited as long as particle speed or elasticity behavior with extremely poor adhesiveness is not exhibited. However, as an extremely flat shape does not allow acceleration, a shape as close to a spherical particle as possible is preferable.

(2c-2) Size of Magnet Powder (Average Powder Diameter)

The size of magnet powder containing rare earth magnet phase of the present embodiment (size of the magnet powder having as a main component a nitrogen compound containing Sm and Fe, in particular, average particle diameter) is only required to be within a range that allows exhibition of the working effect of the present invention, and it is generally in the range of 1 to 10 μm, preferably 2 to 8 μm, and more preferably 3 to 6 μm. When the average particle diameter of magnetic powder is within the range, film forming can be achieved more efficiently by using the cold spray method described below, and it is excellent from the viewpoint of preparing a desired thick magnet film. Specifically, when the average particle diameter is 1 μm or more, particles are not excessively light then optimum particle speed can be obtained. As a result, not only the substrate is not shaven due to excessively fast particle speed but also a desired thick magnet film can be formed by collision, adhesion and deposition onto a substrate at optimum speed. Meanwhile, when the average particle diameter is 10 μm or less, the particles are not excessively heavy then optimum particle speed can be obtained without losing the speed. In other words, since bouncing due to excessively slow speed after collision with a substrate does not occur, a desired thick magnet film can be formed by collision, adhesion and deposition onto a substrate at optimum speed.

As described herein, the average particle diameter of the magnet powder can be measured based on particle size analysis (measurement) such as observation under SEM (scanning electron microscope) or observation under TEM (transmission electron microscope) (see, Examples). Meanwhile, in magnet powder or its cross section, particles with needle shape or rod shape having different length/width ratio (aspect ratio) or amorphous particles, which do not have spherical or circular shape (cross-section shape), may be contained. Thus, the average particle diameter of magnet powder described above corresponds to an average value of absolute maximum length of the cross section shape of each particle within an image under observation, because the particle shape (or its cross section shape) is not uniform. As described herein, the absolute maximum length is the maximum length among the distances between any two points on a silhouette of the particle (or its cross section shape). However, other than that, it can be also obtained by an average value of crystallite diameter obtained by full width at half maximum of diffraction peak of the magnet powder by X ray diffraction or particle diameter of magnet powder obtained from an image of transmission electron microscope. Meanwhile, a method for measuring other particle diameters can be performed similarly.

(3) with Regard to Constitution of Thick Magnet Film Other than Rare Earth Magnet Phase

With regard to the constitution other than rare earth magnet phase in the thick magnet film of the present embodiment, a phase not functioning as a magnet is present in an amount of 2% or so in the entire phase and the remaining consists of voids that are present among adjacent rare earth magnet phases. By having such a constitution, the magnet does not need a resin, comparing to a bond magnet of a related art in which a resin is filled as a binder and molded and solidified then it can be prepared to have lightweight. Further, as the void volume can be further reduced compared to the amount of resin used (binder volume), miniaturization and the increase in density can be achieved. As a result, solidifying and molding with high density is achieved then miniaturization and high performance of a system such as motor can be achieved.

Herein, examples of the phase not functioning as a magnet include a phase of rare earth oxide (NdO₂ phase or SmO₂ phase), formed on a boundary between rare earth magnet phases (main phase•crystalline phase), contamination with Fe or rare earth elements, Fe-rich phase, Fe-poor phase, and other unavoidable impurities.

(4) with Regard to Ratio (%) with Respect to Theoretical Density of Thick Magnet Film

The thick magnet film of the present embodiment has, when R of the rare earth magnet phase represented by the aforementioned R-M-X has Nd as a main component, the density of equal to or more than 80% but less than 95% of theoretical density, and when R has Sm as a main component, it has the density of equal to or more than 80% but less than 97% of theoretical density.

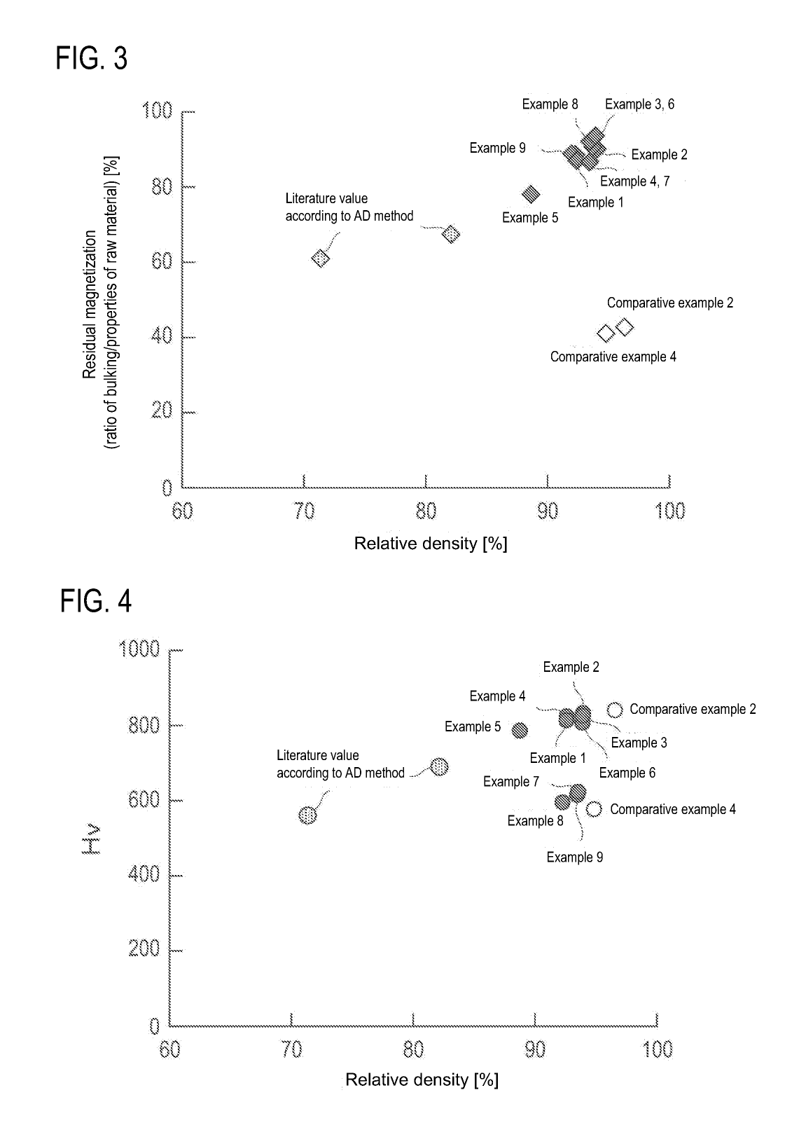

Herein, when R has Nd as a main components, it has the density of equal to or more than 85% but less than 95%, preferably equal to or more than 90% but less than 95%, and more preferably equal to or more than 91% but less than 94% of theoretical density. When the ratio with respect to the theoretical density is equal to or more than 95%, there is a problem that the magnetic properties (in particular, residual magnetization) are not obtained at sufficient level as shown in Table 2 and FIG. 3. Meanwhile, when the ratio with respect to the theoretical density is less than 80%, the effect of improving the magnetic properties (in particular, coercive force and residual magnetic flux density) is not obtained, compared to a bond magnet of a related art. More specifically, there is a problem that the magnetic properties (in particular, residual magnetization) is not obtained at sufficient level as exhibited in the literature values of a related art that are illustrated in FIG. 3.

When R has Sm as a main component, it has the density of equal to or more than 85% but less than 97%, preferably 87 to 96%, more preferably 88 to 95%, and particularly preferably 89 to 94% of theoretical density. When the ratio with respect to the theoretical density is equal to or more than 97%, there is a problem that the magnetic properties (in particular, residual magnetization) are not obtained at sufficient level as shown in Table 1 and FIG. 3. Meanwhile, when the ratio with respect to the theoretical density is less than 80%, the effect of improving the magnetic properties (in particular, coercive force and residual magnetic flux density) is not obtained compared to a bond magnet of a related art. More specifically, there is a problem that the magnetic properties (in particular, residual magnetization) is not obtained at sufficient level as exhibited in the literature values of a related art that are illustrated in FIG. 3. As described in the detailed description and the claims, the term “theoretical density” indicates the density that is obtained from a case in which the main phase of a magnet (rare earth magnet phase) in raw material powder used is considered to have lattice constant obtained by X ray analysis and it occupies 100% volume of a thick magnet film. The ratio with respect to theoretical density is obtained by conversion into the ratio (%) with respect to theoretical density by using that value (value of theoretical density).

(5) Thickness of Thick Magnet Film

A thickness of the thick magnet film of the present embodiment is not particularly limited, and it can be suitably adjusted depending on use. However, since the present embodiment can provide a thicker film than a bond magnet film of a related art, the thickness is generally in the range of 200 to 3000 preferably 500 to 3000 and more preferably 1000 to 3000 μm. In this regard, although there is no particularly significant difference in terms of a film thickness compared to 175 μm (measured value) by the AD method of a related art, there is a problem of peeling when thickening a film more than 175 μm is tried by the AD method of a related art. On the other hand, the present embodiment is quite excellent in that film forming can be achieved without a problem of peeling even for a thick film such as 200 μm to 3000 μm. When a thickness of the thick magnet film is 200 μm or more, a thick magnet film at once satisfying the film thickening, high density, and improved magnetic properties (in particular, residual magnetization=residual magnetic flux density) can be obtained, and therefore it can be applied to very wide range of applications. In particular, since lightweight and miniaturization with high performance can be achieved, it is excellent in that it can be applied to a rare earth magnet of all fields. When a thickness of the thick magnet film is 3000 μm or less, a thick magnet film satisfying at once the film thickening, high density, and improved magnetic properties (in particular, residual magnetization=residual magnetic flux density) that are purposes of the present invention can be obtained, and therefore it can be applied to very wide range of applications. In particular, by suitably applying to a large-size surface magnet synchronous motor or an interior magnet synchronous motor such as electric parts of an automobile, lightweight and also miniaturization with high performance can be achieved then it can greatly contribute to an improvement for miniaturization and lightweight of an electric car or a hybrid car.

(6) Thick Magnet Film Obtained by Using Process of Film Forming from Powder in which Film is Formed by Particle Deposition

The thick magnet film of the present embodiment is obtained by using process of film forming from powder in which film is formed by particle deposition. Merit of this process is that, according to the characteristic constitution of the present invention to increase the magnetic power of the present embodiment itself (cold spray method), 80% or more of the theoretical density, which cannot be obtained by a bond magnet of a related art, can be achieved and the effect of improving magnetic properties (in particular, residual magnetic flux density and hardness) is obtained (see, Examples 1 to 9).

(6a) Particles

As described herein, the particles indicate a raw material powder (or rare earth magnet powder) of a thick magnet film. Specifically, as a raw material powder for constituting the rare earth magnet phase represented by the formula (1); R-M-X, rare earth magnet powder can be used. Alternatively, when X in the formula (1) is N, a part of the constitutional components of the rare earth magnet phase represented by the formula (2); R-M (in the formula, R and M are the same as those of the formula (1)) can be used as a raw material powder. In such a case, R-M of the formula (2) can be treated to be R-M-N of the formula (1) during the production. For example, by adding R-M of the formula (2) as a raw material powder to carrier gas (═N₂ gas) at high temperature and high speed and forming a film by deposition with heating (pressurizing) (=nitrogenation treatment), a thick magnet film having a rare earth magnet phase represented by the formula (1); R-M-X can be prepared.

(6a-1) Average Particle Diameter of Particles

As for the particles to be used, those having average particle diameter in the range of 1 to 10 μm, preferably 2 to 8 μm, and more preferably 3 to 6 μm are used. When the average particle diameter of the rare earth magnet powder is within the above range, optimum particle speed can be obtained by the cold spray method described below then film forming can be achieved more efficiently. Thus, it is favorable from the viewpoint of having a desired thick magnet film. More specifically, when the average particle diameter is 1 μm or more, particles are not excessively light then optimum particle speed can be obtained. As a result, not only the substrate is not shaven due to excessively fast particle speed but also a desired thick magnet film can be formed by collision, adhesion and deposition at optimum speed onto a substrate. Meanwhile, when the average particle diameter is 10 μm or less, the particles are not excessively heavy then optimum particle speed can be obtained without losing the speed. In other words, since bouncing due to excessively slow speed and collision with a substrate does not occur, a desired thick magnet film can be formed by collision, adhesion and deposition at optimum speed onto a substrate.

(6b) Process for Film Forming from Powder in which Particles are Deposited to Form Film

As for the process to film forming by use of powder in which particles are deposited for forming film, it is desirable to process of film forming from powder using a cold spray apparatus which enables obtaining a magnet satisfying at once film thickening, high density, and improved magnetic properties (residual magnetic flux density) that are purposes of the present invention. However, it is not limited to the process of film forming from powder using a cold spray apparatus (cold spray method), and any process of film forming from powder can be used if the working effect of the present embodiment is effectively exhibited.

According to the first embodiment, it has a rare earth magnet phase represented by the formula (1); R-M-X, and when R═Nd is a main component, it has the density of equal to or more than 80% but less than 95% of theoretical density, and when R═Sm as a main component, it has the density of equal to or more than 80% but less than 97% of theoretical density. For such reasons, the net magnet content is increased and a small-sized but strong magnet is obtained. As a result, magnet powder for a bond magnet which has been used by solidifying and molding with a resin in a related art can be solidified and molded at high density, and thus it can contribute to miniaturization and achieving high performance of a motor.

Herein below, the method to produce a thick magnet film (second embodiment) by using a process to form film from powder using a cold spray apparatus (cold spray method) as one typical method for producing the thick magnet film of the present embodiment is explained in view of the drawings.

### (B) Method for Producing Thick Magnet Film (Second Embodiment)

The second embodiment of the present invention relates to use of a method for producing a thick magnet film including a process to film forming from powder film by particle deposition to form a film.

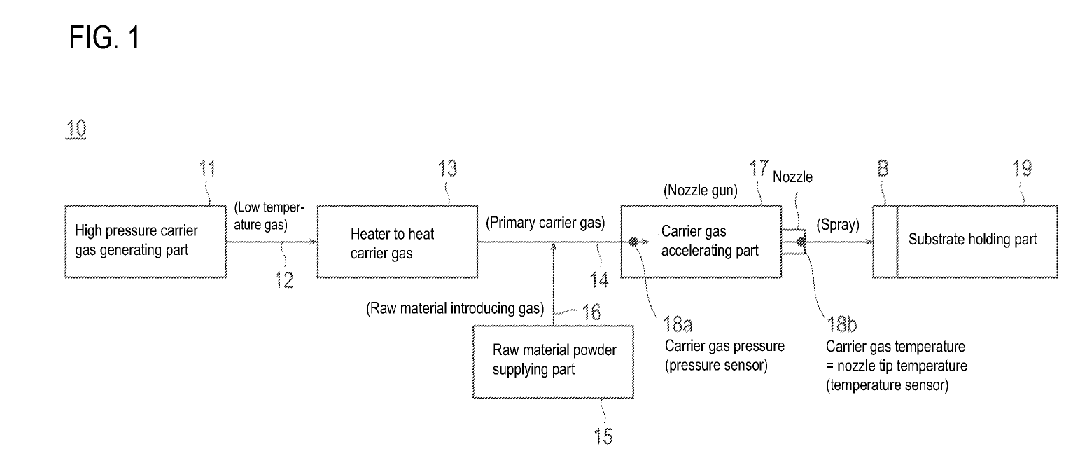

More specifically, the second embodiment is a method for producing a thick magnet film including the following steps (1) and (2). In other words, the method includes a spraying step (1) including spraying a raw material powder with a high speed carrier gas in an accelerated state after mixing a carrier gas and the raw material powder, and a solidifying and molding step (2) including depositing the sprayed the raw material powder on a substrate for solidifying and molding. In addition to them, the present embodiment relates to a method of producing a thick magnet film characterized in that the raw material powder is a rare earth magnet powder, temperature of the high speed carrier gas at the spraying step (1) is lower than the particle growth temperature of crystalline particles of the rare earth magnet powder, and the solidifying and molding step (2) is performed under atmospheric pressure. The second embodiment is, in other words, a method for producing a thick magnet film which uses an apparatus having a high pressure carrier gas generating part, a heater to heat a carrier gas, a raw material powder supplying part, a carrier gas accelerating part, and a substrate holding part. More specifically, primary carrier gas passed through the high pressure carrier gas generating part and the heater to heat a carrier gas and a raw material introducing gas which contains a raw material powder from the raw material powder supplying part are introduced into the carrier gas accelerating part followed by mixing and acceleration, and the resulting high speed carrier gas is sprayed under atmospheric pressure. Thus, it is a method for producing a thick magnet film in which the raw material powder is deposited on a substrate on the substrate holding part by spraying of the high speed carrier gas for solidifying and molding. In addition to above, the present embodiment relates to a method for producing a thick magnet film characterized in that the raw material powder is a rare earth magnet powder and solidifying and molding is performed while the temperature of the high speed carrier gas is lower than the particle growth temperature of crystalline particles of the rare earth magnet powder. According to the present embodiment, a method for producing a magnet satisfying at once the film thickening, high density and improving magnetic properties (in particular, residual magnetic flux density) can be provided without lowering the magnetic properties of magnet powder, and thus a desired thick magnet film (bulk molded product) can be obtained (compare Examples 1 to 9 to Comparative Examples 2 and 4 for reference). As a characteristic not found in the AD method of a related art which is brought by a cold spray method, (1) high density can be achieved by a high particle speed, and thus magnetic properties (∝ density) are improved. (2) Particles with larger size can be sprayed. Thus, an occurrence of local density deviation due to non-uniformity in the thick magnet film, which is caused by aggregated secondary particles (without high density) as a result of micronization of the primary particles, and also deterioration in magnetic properties can be effectively inhibited. As optimization (optimum arrangement) of particles and voids can be achieved by using particles with optimum size, desired ratio (%) with respect to theoretical density can be achieved. (3) Overwhelmingly high film growth speed can be achieved. As a result, a bulk product with thick film is obtained. Based on the properties that are not found in the AD method of a related art, (1) residual magnetization (ratio of bulking/properties of raw material (%)=residual magnetic flux density B (%)) is improved as an effect of a cold spray method (see, Tables 1 and 2 and FIG. 3). (2) High density is reflected in hardness (Hv) (compare the literature values according to AD method of Tables 1 and 2 and FIG. 4 to Examples 1 to 6 for reference). Since the AD method of a related art based on a cold spray method is a kind of a vacuum process, the production needs to be carried out in a vacuum chamber unlike the process under atmospheric pressure. For such reasons, there are problems that the equipment is expensive and the productivity is poor. However, according to the method for producing a thick magnet film of the present embodiment, the process under atmospheric pressure can be used without using a vacuum process (see, FIG. 1). For such reasons, expensive equipment such as a vacuum chamber is not necessary then the cost relating to equipment can be suppressed at low level. As the production in a vacuum chamber is not necessary, the productivity can be also increased.

(1) Cold Spray Apparatus

Cold spray apparatus is an apparatus to form a film by colliding a raw material powder at ultra high speed, with carrier gas, in solid state to a substrate while the raw material powder is neither melted nor gasified.

FIG. 1 is a schematic drawing diagrammatically illustrating the constitution of a cold spray apparatus used for the cold spray method, which is a typical method to form a film from powder in which the film is formed by depositing particles, as used for the method to produce a thick magnet film of the present invention.

As illustrated in FIG. 1, basic constitution of the cold spray apparatus 10 of the present embodiment includes the high pressure carrier gas generating part 11, the heater to heat a carrier gas 13, the raw material powder supplying part 15, the carrier gas accelerating part 17, and the substrate holding part 19. Between the high pressure carrier gas generating part 11 and the heater to heat a carrier gas 13, the pipe 12 is installed for pressure transport of (high pressure) carrier gas (=low temperature gas) at low temperature (room temperature or temperature in non-heated state). Between the heater to heat a carrier gas 13 and the carrier gas accelerating part 17, the pipe 14 is installed for pressure transport of high temperature carrier gas (=primary carrier gas) which has been heated by the heater to heat a carrier gas 13. For introducing a raw material powder from the raw material powder supplying part 15 to the carrier gas accelerating part 17, the pipe 16 to inject a raw material introducing gas from the raw material powder supplying part 15 into the carrier gas accelerating part 17 is installed. The space (distance) between tip (for example, of movable nozzle) of the carrier gas accelerating part 17 and the surface of the substrate B placed on the substrate holding part 19 is positioned (arranged) such that it has a constant interval. The space between the carrier gas accelerating part 17 and the substrate holding part 19 is under atmospheric pressure (air atmosphere). With such a constitution of the apparatus, upon the operation of the apparatus 10, a raw material powder is sprayed (at ultra high speed) from the carrier gas accelerating part 17 to a substrate surface on the substrate holding part 19, with an aid of (high temperature and high pressure) high speed carrier gas accelerated in the carrier gas accelerating part 17. Herein below, each constitutional member of the apparatus is explained.

(1a) High Pressure Carrier Gas Generating Part

Herein, the high pressure carrier gas generating part 11 is not particularly limited, and examples thereof include high pressure gas bombe or high pressure gas tank in which a carrier gas is sealed, high pressure liquefied bombe, high pressure liquefied tank, or gas compressor in which a carrier gas liquefied under high pressure is sealed, but not limited thereto. Meanwhile, the high pressure carrier gas transported under pressure from the high pressure carrier gas generating part 11 is generally at low temperature (=room temperature) state. However, a liquefied gas at temperature lower than room temperature or a gas heated by a heater to have temperature higher than room temperature can be also suitably used.

(1b) Heater to Heat Carrier Gas

The heater to heat a carrier gas 13 is not particularly limited, and it may have a constitution (structure) in which internal pipe for passing carrier gas is prepared in coil form so that current is allowed to flow around the coil region and the internal pipe is used as a heater to heat the carrier gas within the pipe. Alternatively, it also may have a constitution (structure) in which a heater is attached to a periphery of the internal pipe for passing carrier gas, or the heater coil is wound to form a heater to heat and the carrier gas within the pipe is heated. Alternatively, it also may have a constitution (structure) in which a heater is attached to an inner surface of the internal pipe for passing carrier gas, or the heater coil is wound to form a heater to heat and the carrier gas within the pipe is heated. It is also possible to have a constitution (structure) in which carrier gas within a pipe is heated by using an infrared heater or an electronic induction coil, and thus it is not particularly limited. However, the present embodiment is not limited them, it is sufficient to have any constitution that can be effectively used as a means for heating gas, and it can be suitably selected from known means for heating gas of a related art. As for the internal pipe inside the heater to heat a carrier gas 13, a pipe made of steel such as carbon steel or stainless steel (SUS), high strength Ni alloy, high strength Fe alloy, Ti alloy, or so-called super strength metallic material, which have not only pressure resistance, corrosion resistance, and weather resistance but also heat resistance resisting a high temperature of less than 780° C. (see, Comparative Example 4 of Table 2) can be used. However, the present embodiment is not limited to them, and any one effectively usable as a pipe is sufficient, and it can be suitably selected from known groups of a pipe of a related art.

(1c) Pipe for Connecting High Pressure Carrier Gas Generating Part to Heater to Heat Carrier Gas

As for the connecting pipe 12 which is usable for the present embodiment, it is sufficient that those have pressure resistance, corrosion resistance, weather resistance, or the like which are not broken or corroded by a high pressure carrier gas that is transported under pressure from the high pressure carrier gas generating part 11. Thus, it is possible to use a pipe made of steel such as carbon steel or stainless steel (SUS), a metallic material such as copper alloy, Ni alloy, Fe alloy, Ti alloy, or Al alloy, engineering plastics such as acrylic resin, polyamide resin, or polyimide resin, carbon fiber material, or a pressure resistant resin material such as Teflon (registered trade mark of a fluororesin by DuPont, USA). However, the present embodiment is not limited to them, and any one effectively usable as a pipe is sufficient, and it can be suitably selected from known groups of a pipe of a related art. Meanwhile, when the pipe 12 is also used as an internal pipe of the heater to heat a carrier gas 13, it is desirable to use a pipe made of steel such as carbon steel or stainless steel (SUS), a metallic material such as copper alloy, Ni alloy, Fe alloy, Ti alloy, or Al alloy, which have not only pressure resistance, corrosion resistance, and weather resistance but also heat resistance allowing endurance to high temperature of less than 780° C. (see, Comparative Example 4 of Table 2).

(1d) Pipe Connecting Heater to Heat Carrier Gas to Carrier Gas Accelerating Part

As for the connecting pipe 14 which is usable for the present embodiment, it is sufficient that those have heat resistance, pressure resistance, corrosion resistance, weather resistance, or the like which are not melted, softened, broken, or corroded by high temperature and high pressure gas transported under pressure from the heater to heat a carrier gas 13. Thus, it is possible to use a pipe made of steel such as carbon steel or stainless steel (SUS), a metallic material such as copper alloy, Ni alloy, Fe alloy, Ti alloy, or Al alloy, and so-called super strength metallic material. Meanwhile, with regard to the heat resistance, it is desirable to have heat resistance showing endurance to high temperature of less than 780° C. (see, Comparative Example 4 of Table 2). With regard to the pressure resistance, it is desirable to have pressure resistance allowing endurance to gas pressure of more than 0.5 MPa but equal to or less than 5 MPa (see, Example 1 or Comparative Example 1 of Table 1, and Example 9 of Table 2). By an integrated nozzle structure, it is also possible for the heater to heat a carrier gas 13 and the carrier gas accelerating part 17 to have a structure which does not necessarily requires the connecting pipe.

(1e) Raw Material Powder Supplying Part

To the raw material powder supplying part 15, part of the carrier gas from the high pressure carrier gas generating part 11 is transported under pressure via a pipe (not illustrated) to form raw material introducing gas in which the raw material powder and a carrier gas are adjusted to have a pre-determined mixing ratio. Alternatively, in the raw material powder supplying part 17, it is also possible that the carrier gas is transported under pressure via a pipe (not illustrated) from a high pressure carrier gas generating part (not illustrated) that is different from the high pressure carrier gas generating part 11. Also in such a case, a raw material introducing gas in which the raw material powder and a carrier gas are adjusted to have a pre-determined mixing ratio is formed. Meanwhile, in the present embodiment, the method for producing the raw material introducing gas obtained by mixing the raw material powder and carrier gas is not particularly limited, and it is needless to say that it can be suitably selected from other known production methods of a related art, and used. The pipe 14 can be connected to the pipe 16 so that the raw material introducing gas from the raw material powder supplying part 15 is mixed with carrier gas within the pipe 14.

(1f) Pipe for Connecting Raw Material Powder Supplying Part to Carrier Gas Accelerating Part

As for the connecting pipe 16 which is usable for the present embodiment, it is sufficient that those have pressure resistance, corrosion resistance, weather resistance, or the like which are not broken or corroded by high pressure carrier gas transported under pressure from the high pressure carrier gas generating part 11 or a separate high pressure carrier gas generating part (not illustrated). Thus, it is possible to use a pipe made of steel such as carbon steel or stainless steel (SUS), a metallic material such as copper alloy, Ni alloy, Fe alloy, Ti alloy, or Al alloy, engineering plastics such as acrylic resin, polyamide resin, or polyimide resin, or a pressure resistant resin material such as carbon fiber material. However, the present embodiment is not limited to them, and any one effectively usable as a pipe is sufficient, and it can be suitably selected from known groups of a pipe of a related art. When the pipe 16 is introduced further into the inside of the carrier gas accelerating part 15 and used to spray after preparing the raw material powder with high temperature and high pressure carrier gas to have ultra high speed, it is desirable to use a pipe made of steel such as carbon steel or stainless steel (SUS), or a metallic material such as copper alloy, Ni alloy, Fe alloy, Ti alloy, or Al alloy, which have an excellent heat resistance that can endure high temperature of less than 780° C. (see, Comparative Example 4 of Table 2) in addition to the pressure resistance, corrosion resistance, weather resistance, or the like.

(1g) Carrier Gas Accelerating Part

The carrier gas accelerating part 17 which may be used in the present embodiment is not particularly limited, and any one effectively usable as a means to accelerate a gas is sufficient. It can be suitably selected from the known means for accelerating gas of a related art. Specifically, since an aspirator type nozzle gun or the like is used in the carrier gas accelerating part 17, when the carrier gas is made to flow in horizontal direction, the flow rate will increase in a narrow region of the carrier gas accelerating part 17, and thus the carrier gas can be accelerated. As the flow rate increases in a narrow region of the carrier gas accelerating part 17, the pressure is lowered due to Venturi effect. To the carrier gas with lowered pressure, the raw material introducing gas is introduced from the pipe 16, and as a result, a mechanism (principle or structure) can be utilized: in which the inlet part of the pipe 16 has lowered pressure then the raw material introducing gas is injected under the lowered pressure. However, if there is a huge difference in gas pressure between the carrier gas and the raw material introducing gas, there is a possibility of having backflow of the heated primary carrier gas to the pipe 16. As such, the low temperature gas 12 is generally divided into two series so that one of them is used as the primary carrier gas and the other is used as a raw material introducing gas to supply high pressure gases to the raw material powder supplying part. While backflow of the raw material powder is constantly prevented by installing at each of the two divided series a pressure-reducing valve for pressure adjustment, the powder supply can be made. Herein below, explanations are made for a case in which the aforementioned nozzle gun is used as the carrier gas accelerating part 17, but it is not limited thereto, and it can be said that the same explanations shall apply even when other means of accelerating gas described above is used.

(1h) Pressure Sensor 18a

As illustrated in FIG. 1, in the present embodiment, it is desirable that the pressure sensor 18a to measure the pressure of a carrier gas containing the raw material powder is installed inside the carrier gas accelerating part 17 (for example, inside the chamber of a nozzle gun). That is because, by making the gas pressure (gas pressure of carrier gas containing raw material powder) more than 0.5 MPa at spraying, a method for producing a thick magnet film satisfying at once the film thickening, high density, and improving the magnetic properties (in particular, residual magnetic flux density) can be obtained. Examples of the adjustment include a method of controlling (adjusting) pressure or the like of the carrier gas generated from the high pressure carrier gas generating part 11 or pressure of the raw material introducing gas, but not limited thereto. As for the pressure sensor 18a, those allowing accurate measurement down to 0.1 to 5.0 MPa or so as exhibited in Examples are desirably used. Specifically, examples of the one usable even in high temperature gas stream include XCE, or HEM series manufactured by Kulite.

(1i) Temperature Sensor 18b

As illustrated in FIG. 1, in the present embodiment, it is desirable that the temperature sensor 18b to measure the temperature of a carrier gas containing the raw material powder is installed inside the carrier gas accelerating part 17 (for example, tip of the spray nozzle of a nozzle gun). When the temperature of the carrier gas inside the carrier gas accelerating part 17 is made to be the temperature lower than the particle growth temperature of crystalline particles of rare earth magnet powder, the raw material powder can collide and adhere (deposit) at ultra high speed to the substrate B together with the carrier gas, while the powder remains in a solid phase without being melted or gasified, to solidify and mold a film (thick magnet film). Accordingly, a thick magnet film satisfying at once the film thickening, high density, and improved magnetic properties (in particular, residual magnetic flux density) can be obtained. For the adjustment, a method of controlling (adjusting) condition to heat the high pressure carrier gas inside the heater to heat a carrier gas 13 can be exemplified, but the adjustment is not limited thereto. As for the temperature sensor, those allowing accurate measurement of 150 to 800° C. or so as described in Examples are desirably used. Specific examples thereof which may be used include a K type thermocouple.

(1j) Substrate Holding Part 19

The substrate holding part 19 which may be used in the present embodiment is not particularly limited, as long as it can maintain the substrate so that raw material powder remained in a solid phase state is, together with the carrier gas, collided at ultra high speed to the substrate to form a film. Specific examples thereof include those having excellent pressure resistance, corrosion resistance, or weather resistance so that the substrate is strongly fixed without breaking even when the raw material powder in a solid phase state is, together with the high temperature and high pressure carrier gas, collided at ultra high speed to a substrate to form a film. It is preferable to use a member with high heat conductivity which is suitable for effective release of heat to prevent the substrate from melting or gasification as a result of high temperature caused by heating when spraying with carrier gas or collision and deposition of raw material powder. From this point of view, a substrate holding part using steel such as carbon steel or stainless steel (SUS), a metallic material such as copper alloy, Ni alloy, Fe alloy, Ti alloy, or Al alloy, various ceramic materials, or mineral materials (stone plate, rock plate, or the like) is preferably used. In order to release heat effectively, it is also possible to have the substrate holding part 19 equipped with a cooling means. A conventionally known cooling means, for example, forming a cooling flow path for circulating a coolant (for example, water) inside the substrate holding part 19, can be suitably applied.

The aforementioned cold spray apparatus 10 has a constitution (structure) in which a high temperature and high pressure carrier gas at high speed as accelerated in the carrier gas accelerating part 17 and the raw material introducing gas are sprayed (at high speed) from the carrier gas accelerating part 17 to the surface of the substrate B on the substrate holding part 19. At that time, the raw material powder has temperature-controlled by heating of carrier gas in the heater to heat a carrier gas 13 as a previous step so that the powder is not melted or gasified during gas-solid mixing with the high temperature and high pressure carrier gas inside the carrier gas accelerating part 15. Accordingly, the powder is sprayed at ultra high speed, together with the high temperature and high pressure carrier gas, from the tip of the carrier gas accelerating part 17 without melting nor gasifying the raw material powder, and collided and adhered (deposited) in a solid phase state to a surface of the substrate B on the substrate holding part 19 to form a film (thick film) by solidification. Since the carrier gas temperature is a critical condition of the present embodiment, it is explained separately.

(1k) Distance Between Tip of Carrier Gas Accelerating Part and Surface of Substrate B on Substrate Holding Part

The tip of the carrier gas accelerating part 17 (for example, nozzle gun) and surface of substrate B disposed on the substrate holding part 19 (=distance between spray nozzle (spray pressure) and substrate) are desirably disposed (arranged) with a certain interval between them. The space (distance) between the tip of the carrier gas accelerating part 17 (nozzle gun) and surface of substrate B disposed on the substrate holding part 19 has a certain interval in the range of 5 to 30 mm, preferably 5 to 20 mm, and more preferably 5 to 15 mm. Since the space allowing escape of the sprayed carrier gas is limited and the gas remained due to the difficulty of escape works as a resistance, it required a certain distance for the carrier gas to escape desirably. From this point of view, it can be said that the distance between the spray nozzle (spray pressure) and the substrate needs to be 5 mm or more. In other words, when the distance between the spray nozzle (spray pressure) and the substrate is 5 mm or more, the carrier gas can easily escape, and thus it is unlikely to be a resistance. It is also favorable in that the carrier gas can effectively escape to surroundings. Meanwhile, the distance between the spray nozzle (spray pressure) and the substrate of 30 mm or less is advantageous in that the raw material powder (rare earth magnet powder) is not excessively slowed down by air resistance but it can be desirably deposited at ultra high speed, together with the carrier gas, according to collision and adhesion to a substrate while it remains in a solid phase state. It is needless to say that the carrier gas can be efficiently recovered and used again.

(1l) Substrate B

(1l-1) Material of Substrate B

Examples of a material of the substrate B include a metallic substrate such as Cu, stainless steel (SUS), Al, or carbon steel, and a ceramic substrate such as silica, magnesia, zirconia, and alumina. Cu and Al having a characteristic of easy heat release and relatively low cost are preferable. Among them, from the viewpoint of the easiest heat release, relatively stable and cheap cost, and the lower power use amount than Al during a production process (=less generation of Co₂), Cu is one of the most preferred mode.

(1l-2) Shape of Substrate B

Although the substrate B on the substrate holding part 19 is explained above that the entire surface of the substrate B has a flat surface structure such as flat plate, even when the substrate B has a shape with curve such as barrel (cylinder) shape and spherical shape, the thick magnet film can be formed on a desired region with a shape such as barrel (cylinder) shape and spherical shape by using a known coating technique. For example, a uniform coating film (multilayer coating film) is formed by using a nozzle gun (spray gun) and the substrate holding member 19 on a surface of an automobile (for example, body) or a home appliance having non-uniform and complex curved surfaces as exhibited in a technique of coating an automobile or a home appliance. Also in the present embodiment, a desired thick magnet film can be formed (coated) on a surface of the substrate B (including inner surface) in any shape by applying the previously established technique of coating an automobile or a home appliance.

In other words, the substrate B is not particularly limited, and it can have any shape corresponding to various applications in a very broad range in which a rare earth magnet is used. Specifically the substrate B can have any shape corresponding to carious applications in a very broad range in which a rare earth magnet is used, for example, consumer electronics field such as a motor to drive rotary head such as capstan motor of audio equipment, speaker, headphone, a motor to pick up CD, or winding in a camera, actuator to focus, or video equipment, motor to zoom, motor to focus, capstan motor, optical pickup for DVD or Blu-ray, air conditioning compressor, fan motor for outdoor unit, or a motor for electric shave; peripheral equipment for a computer and OA equipment such as voice coil motor, spindle motor, optical pickup for CD-ROM and CD-R, stepping motor, plotter, actuator for printer, dot printer print head, or rotating sensor for copying machine; precision devices in the field of measurement, communications, and others such as stepping motor for watch, various meter, pager, vibration motor for cellular phone (including cellular information terminals), motor to drive recorder pen, accelerator, undulator for light radiation, polarized magnet, ion source, various plasma sources in a device for manufacturing semiconductor, electronic polarization, or magnetic inspection bias; medical fields such as permanent magnetic type MRI, electrocardiography device, electroencephalography device, dental drill motor, magnet to fix teeth, or magnetic necklace; FA fields such as AC servo motor, synchronous motor, brake, clutch, torque coupler, linear motor for transportation, or lead switch; and electric components and devices of an automobile such as retarder, ignition coil transformer, ABS sensor, detection sensor for rotation or position, sensor for suspension control, door lock actuator, ISCV actuator, motor for driving electric vehicle, motor for driving hybrid vehicle, motor for driving fuel cell vehicle, power steering, optical pickup for car navigation. However, the use in which the rare earth magnet of the present embodiment is used is not limited at all to the aforementioned extremely small area of products (parts), and it is needless to say that it can be widely used for general applications in which the rare earth magnet is currently used. It is also possible that, by using a substrate as a releasing material and peeling (removing) only a thick magnet film which is formed on a substrate from the surface of a substrate, it can be used for various applications. For such a case, it is sufficient that the shape of a substrate is prepared to have a shape applicable for the use, and examples thereof include a plate (disc) shape of polygon (triangle, square, trapezoid, hexagon, circular shape or the like), a wave plate polygon (triangle, square, trapezoid, hexagon, circular shape or the like), and a donut shape, but not particularly limited.

Outline of the cold spray apparatus 10 of the present embodiment is as described above. However, the present embodiment is not limited to them, and it is sufficient to have an apparatus which allows film formation by ultra high speed collision of raw material powder with carrier gas to a substrate while the raw material powder is in a solid phase state without being melted or gasified. A known apparatus for cold spray can be suitably used.

(2) Cold Spray Method

Cold spray method is a method for forming a film by colliding at high speed, with carrier gas, raw material powder in solid state to a substrate while the raw material powder is neither melted nor gasified.

The present embodiment is a method to produce a thick magnet film by depositing, solidifying and molding of raw material powder with carrier gas according to addition of a raw material powder to high speed carrier gas by a cold spray method which uses the cold spray apparatus 10 described above. Specifically, in the cold spray apparatus 10, the raw material powder is introduced without being melted or gasified to a high speed carrier gas so that the raw material powder remained in a solid phase state is collided and adhered, together with the carrier gas, to a substrate at ultra high speed to form a film. It also relates to a method of solidifying and molding of a deposit (thick magnet film) by depositing the raw material powder on a substrate as a result of repeating the operations. The present embodiment is characterized in that the raw material powder is rare earth magnet powder and the solidifying and molding is performed at the carrier gas temperature which is lower than the particle growth temperature of crystalline particles of the rare earth magnet powder.

(2a) Carrier Gas

Herein, any gas can be used as carrier gas. For more favorable magnetic properties, inert gas such as rare gas (He, Ne, Ar, Kr, Xe, Rn), and nitrogen gas (N₂) can be exemplified. However, inert gas such as Ar, He, and N₂, which is easily obtainable, cheap, and not causing deterioration of the magnetic properties, is preferably used. Use of those inert gas as carrier gas is favorable in that a thick magnet film with high density (bulk molded product) can be obtained without lowering magnetic properties of rare earth magnet powder. N₂ is advantageous in that the nitride is hardly decomposed then heat resistance can be enhanced by using N₂, and He gas is advantageous in that, because of small molecular weight, it is easy to obtain gas speed. For preventing from oxidation, hydrogen may be contained, in particular. N₂—H₂ gas is advantageous in that it can be obtained at low cost as ammonia-decomposed gas.

(2b) Preparation of High Speed Carrier Gas

The high speed carrier gas used in the present embodiment is prepared in the following order by using the cold spray apparatus 10. First, a low temperature carrier gas (also referred to as low temperature gas) is generated in the carrier gas generating part 11. The generated low temperature gas is transported under pressure via the pipe 12 and transformed into a high temperature carrier gas (also referred to as primary carrier gas) under heating by a heater, that is, the heater to heat a carrier gas 13. Next, the raw material introducing gas and the primary carrier gas are mixed and adjusted so as to have a pre-determined mixing ratio between the raw material powder and the carrier gas are mixed in the raw material powder supplying part 15, and accelerated in the carrier gas accelerating part 17 for preparation of a high speed carrier gas. After that, the high speed carrier gas containing the raw material powder is sprayed at ultra high speed toward the substrate, thereby forming a thick magnet film on the substrate.

(2c) Low Temperature Gas

As described above, the low temperature gas is a carrier gas at low temperature which is generated by the carrier gas generating part 11.

(2c-1) Temperature of Low Temperature Gas

As described herein, the temperature of the low temperature gas is not particularly limited, as long as it is within the range in which the working effect of the present embodiment is not inhibited. As a general standard, temperature of the low temperature gas is in the range of −30 to 80° C., preferably 0 to 60° C., and more preferably 20 to 50° C. However, it is not limited to those ranges, and as long as it is within the range in which the working effect of the present embodiment is not inhibited, it is needless to say that those outside the range are also included in the technical scope of the present embodiment. When the temperature of the low temperature gas is −30° C. or higher, preferably 0° C. or higher, and particularly preferably 20° C. or higher, there is a merit that dew condensation in a pipe can be prevented and deterioration of the properties of a material as caused by moisture incorporation can be prevented. When the temperature of the low temperature gas is 80° C. or lower, preferably 60° C. or lower, and particularly preferably 50° C. or lower, not only the deterioration of a pipe material can be prevented but also, in terms of safety, a burn can be prevented even when the pipe is touched by hands. Further, as the raw material powder is not exposed to unnecessary high temperature, a thick magnet film with stable quality can be obtained, and also a high pressure bombe or tank can be used at low cost without cooling.

(2c-2) Pressure of Low Temperature Gas

Pressure of the low temperature gas is not particularly limited, as long as it is within the range in which the working effect of the present embodiment is not inhibited. As a general standard, pressure of the low temperature gas is in the range of 0.3 to 10 MPa, and preferably 0.5 to 5 MPa. However, it is not limited to those ranges, and as long as it is within the range in which the working effect of the present embodiment is not inhibited, it is needless to say that those outside the range are also included in the technical scope of the present embodiment. When the pressure of the low temperature gas is 0.3 MPa or higher, and particularly preferably 0.5 MPa or higher, acceleration of powder can be made under high pressure and high speed. When the pressure of the low temperature gas is 10 MPa or lower, and particularly preferably 5 MPa or lower, there is a merit that an investment on highly expensive facilities for a high pressure gas can be suppressed.

(2c-3) Flow Rate and Flow Amount of Low Temperature Gas

Flow rate of the low temperature gas is not particularly limited, if it is within the range in which the working effect of the present embodiment is not inhibited. Flow amount of the low temperature gas is not particularly limited, either, if it is within the range in which the working effect of the present embodiment is not inhibited. Although a generalized defining cannot be made due to a variation depending on specifications of an apparatus, as a general standard for the flow amount of the low temperature gas, it is desirably in the range of 0.1 to 1.0 m³/minute.

(2d) Primary Carrier Gas

Primary carrier gas indicates a high temperature carrier gas which is obtained by transporting the low temperature gas generated in the carrier gas generating part 11 to the pipe 12 under pressure and heating with a heater, that is, the heater to heat a carrier gas 13.

(2d-1) Temperature of Primary Carrier Gas (=Temperature for Heating by Heater)

The temperature for heater heating in the heater to heat a carrier gas 13 (=temperature of primary carrier gas) is not particularly limited, if it is within the range in which the working effect of the present embodiment is not inhibited. Even when the heating temperature by the heater to heat a carrier gas 13 is a high temperature, the time to heat the raw material powder by the heated high temperature carrier gas (primary carrier gas) is extremely short, during which it passes through the inside of a nozzle of the carrier gas accelerating part 17 (nozzle gun) after mixing. As such, it does have almost no influence on the magnetic properties. The heating temperature of the heater is in the range of 200 to 1000° C., preferably 300 to 900° C., and more preferably 400 to 800° C. Since it varies depending on type of gas, temperature of gas, and pressure of gas, it is difficult to determine the temperature of gas only. However, when it is 200° C. or higher, excessive decrease in temperature can be avoided when admixed with the raw material introducing gas, and also adjustment can be made for the gas temperature required for the high speed carrier gas at spraying of the raw material powder obtained by mixing with low temperature raw material introducing gas. Meanwhile, when it is 1000° C. or lower, it is unlikely to deteriorate the raw material powder due to excessively high temperature of the primary carrier gas, and as it is not necessary to use an expensive part or member having excellent heat resistance for the entire carrier gas heating heater 13, it is favorable from the viewpoint of saving production cost. Based on above, the heater heating temperature is preferably in the range of 200 to 1000° C. However, it is not limited to the range, and as long as it is within the range in which the working effect of the present embodiment is not inhibited, it is needless to say that those outside the range are also included in the technical scope of the present embodiment.

(2d-2) Pressure of Primary Carrier Gas

Pressure of the primary carrier gas is not particularly limited, if it is within the range in which the working effect of the present embodiment is not inhibited. As a general standard, pressure of the primary carrier gas is in the range of 0.3 to 10 MPa, and preferably 0.5 to 5 MPa. However, it is not limited to those ranges, and as long as it is within the range in which the working effect of the present embodiment is not inhibited, it is needless to say that those outside the range are also included in the technical scope of the present embodiment. When the pressure of the primary carrier gas is 0.3 MPa or higher, and particularly preferably 0.5 MPa or higher, acceleration to an acceleration speed required for film forming can be made even with heavy metal particles. When the pressure of the primary carrier gas is 10 MPa or lower, and particularly preferably 5 MPa or lower, there is a merit that an investment on highly expensive facilities for a high pressure gas can be suppressed.

(2d-3) Flow Rate of Primary Carrier Gas

Flow rate of the primary carrier gas is not particularly limited, as long as it is within the range in which the working effect of the present embodiment is not inhibited.

(2e) Raw Material Powder

The raw material powder used in the present embodiment is adjusted in the raw material powder supplying part 15 to have a pre-determined mixing ratio with the primary carrier gas, thereby preparing the raw material introducing gas.

Herein, the raw material powder used in the present embodiment is rare earth magnet powder. In this regard, it is the same as those described in detail in (1) to (2c-2) and (6a) above of the first embodiment. Specifically, as a raw material powder for constituting the rare earth magnet phase which is represented by the formula (1); R-M-X, rare earth magnet powder can be used. When X is N (nitrogen), part of the constituting components of the rare earth magnet phase which is represented by the formula (2); R-M (in the formula, R and M are the same as defined in the formula (1)) can be used as a raw material powder. This is because such raw material powder also corresponds to one type of rare earth magnet powder, even though it has a different compound (alloy) composition. For such a case, R-M of the formula (2) turns into R-M-N of the formula (1) during the production process. Specifically, the raw material introducing gas (containing R-M as the raw material powder) is introduced and mixed in the primary carrier gas (high temperature nitrogen gas) (during which nitridation is performed under heating), and after being further accelerated followed by high speed spray, collision, adhesion and deposition on the substrate B is carried out to solidify and mold. Accordingly, a thick magnet film having a nitride-based rare earth magnet phase expressed as R-M-N can be obtained.

(2e-1) Size of Raw Material Powder

As for the raw material powder, different rare earth magnet powder described above can be used. However, in any case, it is preferable that average particle diameter of the rare earth magnet powder is generally in the range of 1 to 10 μm, preferably 2 to 8 μm, and more preferably 3 to 6 μm. In other words, the average particle diameter of the rare earth magnet powder is not particularly limited as long as it allows growth of film and it is within a range in which economic feasibility is not impaired. However, taking account of metal particles with specific gravity of 6 to 8 g/cm³ or so, sufficient particle speed can be obtained when it is within the range of 1 to 10 μm or so. Accordingly, the film can grow, and thus economically favorable. When the average particle diameter of the rare earth magnet powder is within the aforementioned range, an optimum particle speed can be obtained by using the cold spray method. For such reasons, it is favorable in that the film can be grown more efficiently and a desired thick magnet film can be prepared. In other words, with the average particle diameter of 1 μm or more, optimum particle speed can be obtained as the particles are not excessively light. For such reasons, the substrate is not shaven due to excessively high particle speed, collision and adhesion on the substrate can be made at optimum speed, and a desired thick magnet film can be formed by deposition. In addition, without melting or gasifying the raw material powder, a thick film with high density can be formed according to collision at ultra high speed=optimum particle speed to the substrate B together with the carrier gas while it remains in a solid phase state. Since the collision to the substrate B is made at optimum solid temperature and binding (adhesion) on the substrate B and deposition thereon can be made while the particles maintain a suitable space each other without integration (melting fusion), it is favorable in that a deposit (=thick magnet film) with higher density and excellent magnetic properties can be obtained by solidifying and molding. Meanwhile, if the average particle diameter is 10 μm or less, the particles are not excessively heavy then optimum particle speed can be obtained without losing speed. In other words, since the particles are not bounced after collision to a substrate due to excessively slow particle speed, a desired thick magnet film can be formed by collision, adhesion and deposition to a substrate at an optimum speed. In particular, as the raw material powder does not lose its speed by air resistance under atmospheric pressure, it is possible to form a thick film with high density by colliding to the substrate B at optimum particle speed while the powder remains in a solid phase state. It is also favorable in that the raw material powder is not melted or gasified, no breaking occurs even after collision on the substrate B at optimum solid temperature, the binding (adhering) property to the substrate B is excellent, and a deposit (=thick magnet film) with higher density and excellent magnetic properties can be obtained by solidifying and molding.

(2f) Raw Material Introducing Gas

The raw material introducing gas used in the present embodiment is obtained by adjustment in the raw material powder supplying part 15 to have a pre-determined mixing ratio between the raw material powder and the carrier gas for preparing the raw material introducing gas. Herein, the raw material powder is the same as those described above. As for the carrier gas to prepare the raw material introducing gas, the same gas as the aforementioned carrier gas of (2a) can be used. As for the carrier gas of (2a) and the carrier gas to prepare the raw material introducing gas, it is possible to use the same kind or a different kind. From the viewpoint of preventing from a deviation in particle speed due to a difference in their weight, it is desirable to use the same kind.

(2f-1) Temperature of Raw Material Introducing Gas

As described herein, the temperature of the raw material introducing gas is not particularly limited, if it is within the range in which the working effect of the present embodiment is not inhibited. As a general standard, temperature of the raw material introducing gas is in the range of −30 to 80° C., preferably 0 to 60° C., and more preferably 20 to 40° C. However, it is not limited to those ranges, and as long as it is within the range in which the working effect of the present embodiment is not inhibited, it is needless to say that those outside the range are also included in the technical scope of the present embodiment. When the temperature of the raw material introducing gas is −30° C. or higher, preferably 0° C. or higher, and particularly preferably 20° C. or higher, there is a merit that dew condensation in a pipe can be prevented and deterioration of the properties of a material as caused by moisture incorporation can be prevented. When the temperature of the raw material introducing gas is 80° C. or lower, preferably 60° C. or lower, and particularly preferably 40° C. or lower, not only the deterioration of a pipe material can be prevented but also, in terms of safety, a burn can be prevented even when the pipe is touched by hands. As the raw material powder is not exposed to unnecessary high temperature, a thick magnet film with stable quality can be obtained.

(2f-2) Pressure of Raw Material Introducing Gas

Pressure of the raw material introducing gas is not particularly limited, if it is within the range in which the working effect of the present embodiment is not inhibited. As a general standard, pressure of the raw material introducing gas is equal to or higher than that of the primary carrier gas 14.

(2f-3) Flow Rate and Flow Amount of Raw Material Introducing Gas

Flow rate of the raw material introducing gas is not particularly limited, if it is within the range in which the working effect of the present embodiment is not inhibited. As for the flow amount of the raw material introducing gas, it is important that the gas temperature is not unnecessarily high according to the flow amount ratio with respect to the primary carrier gas. The flow amount ratio (flow amount of primary carrier gas/flow amount of raw material introducing gas) is preferably controlled to 1 to 7, and more preferably 2 to 5 or so. When the flow amount ratio is 7 or less, troubles such as clogging of a nozzle or a pipe caused by excessive supply of the raw material powder can be reduced. When it is 1 or higher, the deterioration in properties of the raw material powder, which is caused by a contact with the primary carrier gas at high temperature, can be suppressed.

(2f-4) Mixing of Raw Material Introducing Gas and Primary Carrier Gas (High Speed Carrier Gas)

In the present embodiment, to introduce the raw material powder into the primary carrier gas as raw material introducing gas, the raw material introducing gas from the raw material powder supplying part 17 can be added to the carrier gas accelerating part 15 via the pipe 16. As for the addition amount of the raw material powder to the primary carrier gas (it is also possible to add directly to high speed carrier gas), an excessively small amount is not favorable in terms of economics, and an excessively large amount may cause clogging. The suitable addition amount can be chosen to achieve an optimum adhesion speed on a substrate in view of the balance with the gas flow amount.

(2f-5) Supply Amount of Raw Material Powder

The supply amount of the raw material powder is not particularly limited, if it is within the range in which the working effect of the present embodiment is not inhibited. As a general standard, the supply amount of the raw material powder is in the range of 1 to 100 g/min, preferably 5 to 20 g/min, and more preferably 8 to 10.5 g/min. However, it is not limited to those ranges, and as long as it is within the range in which the working effect of the present embodiment is not inhibited, it is needless to say that those outside the range are also included in the technical scope of the present embodiment. When the supply amount of the raw material powder is 1 g/min or more, the productivity is relatively good then the desired film thickness can be obtained in a short time. Although it may vary depending on mixing ratio with the carrier gas for preparing the raw material introducing gas, at spraying to the substrate B, the particles are not bounced together with the high speed carrier gas after collision to the substrate B due to excessively ultra high speed of the raw material powder. For such reasons, it is favorable in that collision, adhesion and deposition on the substrate B can be achieved. When the supply amount of the raw material powder is 100 g/min or less, there is a merit that troubles such as nozzle clogging can be reduced. Although it may vary depending on mixing ratio with the carrier gas to prepare the raw material introducing gas, the speed of the raw material powder is not lowered at spraying to the substrate B, and thus it is favorable in that ultra high speed collision, adhesion and deposition on the substrate B together with the high speed carrier gas can be achieved.

(2f-6) Mixing Ratio of Primary Carrier Gas and Raw Material Introducing Gas

Mixing ratio of primary carrier gas and raw material introducing gas is not particularly limited, if it is within the range in which the working effect of the present embodiment is not inhibited. As a general standard for the mixing ratio of primary carrier gas and raw material introducing gas, the raw material introducing gas is in the range of 1 to 7 parts by volume, and preferably 2 to 5 parts by volume with respect to 100 parts by volume of the primary carrier gas. However, it is not limited to those ranges, and as long as it is within the range in which the working effect of the present embodiment is not inhibited, it is needless to say that those outside the range are also included in the technical scope of the present embodiment. When the raw material introducing gas is 1 part by volume or more with respect to 100 parts by volume of the primary carrier gas, deterioration of the raw material introducing gas caused by contact with the high temperature primary carrier gas can be suppressed. As there is no problem that the raw material powder exceeds the desired particle speed and collides in solid phase state to the substrate B to cause crushing or no deposition due to bouncing, the film can be favorably formed by collision and deposition. It is also favorable in that a thick magnet film with higher density can be obtained by solidifying and molding as a result of repeating those operations. When the raw material introducing gas is 7 parts by volume or less with respect to 100 parts by volume of the primary carrier gas, troubles such as clogging of a nozzle or a pipe caused by excessive supply of the raw material powder can be reduced. Further, the film can be formed by collision and deposition of the raw material powder, together with the high speed carrier gas, to a substrate at a desired particle speed (ultra high speed) while it remains in a solid phase state. It is also favorable in that a thick magnet film with higher density can be obtained by solidifying and molding by repeating those operations.

(2g) High Speed Carrier Gas

The high speed carrier gas used in the present embodiment is prepared by mixing the raw material introducing gas and the primary carrier gas and accelerating them in the carrier gas accelerating part 17.

(2g-1) Flow Rate of High Speed Carrier Gas

In the present embodiment, flow rate of the high speed carrier gas is accelerated in the carrier gas accelerating part to 17 to 600 m/s or more, preferably to 700 m/s or more, more preferably to 1000 m/s or more, belonging to the region of sound speed, and particularly preferably to high speed range of 1000 to 1300 m/s. When the high speed carrier gas is 600 m/s or more, a film can be formed by, at desired particle speed, collision and adhesion of the raw material powder remained in a solid phase state to a substrate according to the cold spray method. Further, by repeating those operations, deposition can be preferably performed on a substrate, and thus it is favorable in that a desired thick magnet film (product in mm unit) with high density can be solidified and molded. When the high speed carrier gas is 1300 m/s or less, there is no problem that the substrate surface is shaven by the magnet powder (raw material powder), and the raw material powder exceeds the desired particle speed and collides in solid phase state to the substrate B to cause crushing or no-deposition as a result of bouncing. Accordingly, the film can be favorably formed by collision and deposition on a substrate. It is also favorable in that a thick magnet film with higher density can be obtained by solidifying and molding as a result of repeating those operations. Meanwhile, the high speed carrier gas is prepared as high temperature and high pressure carrier gas (primary carrier gas) after passing through the carrier gas generating part 11 and the heater to heat a carrier gas 13 until it is introduced to the carrier gas accelerating part 17.

(2h) High Speed Spray of High Speed Carrier Gas Toward Substrate

In the present embodiment, by high speed spray of the high speed carrier gas from the carrier gas accelerating part 17 toward a substrate disposed (fixed) on the substrate holding part 19, a film is formed as a result of collision and adhesion on the substrate, and also deposition, solidification and mold, a desired thick magnet film is obtained. As a result, a thick magnet film having excellent magnetic properties (in particular, residual magnetic flux density and hardness) due to an increased film thickness and high density can be obtained.

(2h-1) Particle speed (spray speed)≈collision speed on substrate B

According to the present embodiment, the raw material powder is sprayed (at high speed) with the carrier gas under atmospheric pressure from the nozzle tip of the carrier gas accelerating part 17 (nozzle gun), and collided and bound (adhered) on the substrate B for deposition, thereby a deposit (=thick magnet film) is solidified and molded. As for the speed (spray speed) at (high speed) spraying of the raw material powder with carrier gas≈collision speed on substrate B (herein below, simply referred to as particle speed), it is not particularly limited, if it is within the range in which the working effect of the present embodiment is not inhibited. The particles speed for high speed spray of the raw material powder with the carrier gas is accelerated to 600 m/s or more, preferably to 700 m/s or more, more preferably to 1000 m/s or more, belonging to the region of sound speed, and particularly preferably to high speed range of 1000 to 1300 m/s. When the particle speed is 600 m/s or more, a film can be formed by, at desired particle speed, collision and adhesion of the raw material powder remained in a solid phase state to a substrate by the cold spray method, because the raw material powder does not lose its speed by air resistance under atmospheric pressure. Further, by repeating those operations, deposition can be preferably made on a substrate, and thus it is favorable in that a desired deposit (thick magnet film; product in mm unit) with high density can be solidified and molded. When the particle speed is 1300 m/s or less, it is favorable in that the ultra high speed can be maintained without suppressing part of the elaborately obtained kinetic energy, which is caused by an occurrence of friction sound by exceeding the speed of sound from spray to collision. The substrate surface is not shaven by the magnet powder (raw material powder) and there is no bouncing of the raw material powder after collision to the substrate as caused by excessively high particle speed of the raw material powder at the time of spraying to the substrate B. There is also no problem that the raw material powder exceeds the desired particle speed and collides in solid phase state to the substrate B to cause crushing or no-deposition as a result of bouncing. Accordingly, the film can be favorably formed by collision and deposition on the substrate B. It is also favorable in that a thick magnet film with higher density can be obtained by solidifying and molding as a result of repeating those operations.

(2h-2) Atmosphere of Spray Region

The reason of atmospheric pressure (environment of atmospheric pressure) for the spray region from the nozzle tip of the carrier gas accelerating part 17 (nozzle gun) to the substrate B in the present embodiment is to solve the problems associated with AD method, which is conventionally performed under reduced pressure (see, section of “Problem to be Solved by the Invention”). In addition, by keeping the spray region under atmospheric pressure, the raw material powder (rare earth magnet powder) which has been collided and bound (adhered) on the substrate B can transfer heat quickly from the substrate B to substrate holding part 19 having a large surface area, and thus it is favorable in terms of achieving solidification and mold while heat removing=releasing heat to atmosphere.

(2i) Temperature of High Speed Carrier Gas

The present embodiment is characterized in that solidifying and molding is achieved while the temperature of the high speed carrier gas is kept below the particle growth temperature of the crystalline particle of the rare earth magnet (raw material powder). Herein, the temperature of the high speed carrier gas indicates a temperature at the time of high speed spray (particularly just before spraying) toward the substrate B from the nozzle tip of the carrier gas accelerating part 17 (nozzle gun), and it can be measured by the temperature sensor 8b installed on the nozzle tip of the carrier gas accelerating part 17 (nozzle gun).

(2i-1) Overview of R-M-X (for a Case in which Rare Earth Magnet does not Contain Nitride, in Particular)

It is sufficient that the temperature of the high speed carrier gas is lower than the particle growth temperature of the crystalline particle of a rare earth magnet (raw material powder). The reason is that, when the temperature of the high speed carrier gas is lower than the particle growth temperature of the crystalline particle of a rare earth magnet (raw material powder), the particle growth of the crystalline particle of a rare earth magnet can be prevented then favorable magnetic properties (residual magnetic flux density and hardness Hv) can be maintained. However, as the particle growth temperature of the crystalline particle of a rare earth magnet (raw material powder) also varies depending on type (material) of a rare earth magnet (raw material powder), it cannot be defined uniquely. Thus, as an example, when a rare earth magnet R-M-X is Nd—(Fe—Co)—B, more specifically (Nd.Zr)(Fe—Co)BGaAl (see, Examples 7 to 9), particle growth of the crystalline particle of a rare earth magnet (raw material powder) has occurred at the temperature of 740° C. or more. From this point of view, the temperature of the high speed carrier gas is equal to or higher than 350° C. but lower than 740° C., preferably in the range of 400 to 720° C., more preferably 420 to 710° C., and particularly preferably 450 to 700° C. However, the present embodiment is not limited to the range, and the optimum temperature of the high speed carrier gas can be suitably determined for each type (material) of the rare earth magnet (raw material powder) within a range in which the working effect of the present embodiment is not inhibited. Herein, with regard to the particle growth temperature of the crystalline particle of a rare earth magnet (raw material powder), the raw material powder (raw material magnet powder) is subjected for the heating treatment in vacuum for 1 min of soaking time, and the magnetic properties are evaluated and the temperature at which the magnetic properties start to deteriorate is analyzed. A sample at such temperature is subjected to analysis of crystalline particle diameter based on X ray analysis, and the temperature at the time point at which deterioration of the magnetic properties is caused by coarsification of the crystalline particles is taken as the particle growth temperature (growth start temperature) of the crystalline particles of a rare earth magnet (raw material powder). For example, when the deterioration of the magnetic properties is found at the temperature of 740° C. or higher as a result of evaluation of the magnetic properties, a sample at the temperature where the properties start to deteriorate (740° C.) is subjected to analysis of crystalline particle diameter by X ray analysis, and the time point at which deterioration of the magnetic properties is found to be caused by coarsification of the crystalline particles, the corresponding temperature 740° C. is taken as the particle growth temperature (growth start temperature) of the crystalline particles of a rare earth magnet (raw material powder).

(2i-2) for a Case in which are Rare Earth Magnet Contains Nitride

When the rare earth magnet (raw material powder) contains a nitride, the magnet is preferably obtained by solidifying and molding at the condition that a temperature of the high speed carrier gas is desirably lower than the decomposition temperature of the nitride.

Accordingly, a method to produce a magnet satisfying at once an increased film thickness, particularly excellent high density and magnetic properties (particularly excellent residual magnetic flux density) can be provided without inhibiting the magnetic properties of a magnet powder, and thus a desired thick magnet film (bulk molding product) can be obtained (compare Examples 1 to 6 to Comparative Example 2 for reference). Also for a case in the rare earth magnet (raw material powder) contains a nitride, temperature of the high speed carrier gas varies depending on type (material) of the rare earth magnet (raw material powder), and thus it cannot be defined uniquely. For example, when the rare earth magnet R-M-X is Sm—Fe—N, more specifically Sm₂Fe₁₄Nₓ(x=2 to 3) (see, Examples 1 to 6), decomposition occurred at 450° C. or higher. From this point of view, the temperature of the high speed carrier gas is equal to or higher than 100° C. but lower than 450° C., preferably in the range of 150 to 400° C., more preferably 170 to 380° C., and particularly preferably 200 to 350° C. (see, Examples 1 to 6 and Comparative Example 2). When the temperature of the high speed carrier gas is equal to or higher than 100° C., adhesion easily occurs upon collision to a substrate and also the productivity is excellent, and therefore preferable. Further, when the temperature of the high speed carrier gas is less than 450° C., decomposition of the rare earth magnet (raw material powder)=nitride can be suppressed, and thus it is favorable in terms of suppressing the deterioration of the magnetic properties. However, the present embodiment is not limited to the range, and the optimum temperature of the high speed carrier gas can be suitably determined for each type (material) of the rare earth magnet (raw material powder) within a range in which the working effect of the present embodiment is not inhibited. Herein, when the rare earth magnet (raw material powder) contains a nitride, the decomposition temperature of nitride was determined based on DSC (differential scanning calorimetry) analysis. For example, when decomposition of the raw material powder occurs at 450° C. or higher, decomposition temperature of the rare earth magnet (raw material powder)=nitride (decomposition start temperature) is 450° C.

When the rare earth magnet (raw material powder) contains a nitride, the decomposition temperature of the nitrogen compound (nitride) is generally 520 to 530° C. in a rare earth magnet other than those exemplified above. Accordingly, the temperature of the high speed carrier gas is lower than the decomposition temperature. Higher energy can be given to magnet powder (raw material powder) as the temperature of the high speed carrier gas increases. For such reasons, at the temperature below the decomposition temperature of a nitrogen compound, particles of the nitrogen compound (in particular, near surface) will not decompose even for a short time, and thus it is preferable in that the desired magnetic properties can be effectively exhibited. Temperature of the high speed carrier gas is preferably 500° C. or less, more preferably in the range of 100 to 500° C., even more preferably 100 to 400° C., and particularly preferably 200 to 300° C. When it is 100° C. or higher, adhesion and deposition on a substrate can be achieved, and thus it could be desirable in terms of the productivity.

As described herein, temperature of the high speed carrier gas indicates a temperature of the accelerated high speed carrier gas containing the raw material powder as described above. In the specification, a carrier gas before heating is referred to as low temperature gas, a heated carrier gas before introducing the raw material powder is referred as primary carrier gas, and a gas to supply the raw material powder at room temperature is referred to as raw material introducing gas, so as to distinguish them from the high speed carrier gas (see, FIG. 1). Temperature of the high temperature carrier gas corresponds to a temperature of the mixture of the primary carrier gas heated by the heater to heat a carrier gas 13 and the raw material introducing gas. Temperature adjustment can be performed based on gas pressure ratio between the primary carrier gas and the raw material introducing gas. With regard to the gas pressure ratio between the primary carrier gas and the raw material introducing gas required to achieve the carrier gas temperature, conditions (gas pressure ratio) are desirably determined in advance based on a trial and error in a preliminary test or the like while monitoring the temperature. This is because it varies as the nozzle diameter of the cold spray apparatus in use is changed or type of the gas or temperature of the gas is changed.

Meanwhile, the temperature of the high speed carrier gas which is sprayed in a mixture state with the raw material powder has an influence on temperature of the substrate. The magnet formed as a film on the substrate B (film→thick film) is exposed to the gas temperature for a long period of time, and if the temperature of the high speed carrier gas is excessively higher than the temperature conditions described above, it may cause a deterioration of the magnetic properties. Meanwhile, even when the temperature of the high speed carrier gas is within the temperature range defined above, slow cooling (water cooling or air cooling) can be performed, if required. It is also possible to stabilize the temperature of a magnet formed as a film on the substrate B (film thick film) by using the substrate holding part 19 having good heat absorbing property.

As described above, the reason for making the temperature of the high speed carrier gas lower than the particle growth temperature of the crystalline particles of a rare earth magnet is that the magnetic properties are deteriorated by particle growth of the crystalline particles of a rare earth magnet (see, Comparative Examples 2 and 4).

(2j) Solidifying and Molding of Thick Magnet Film on Substrate by Ultra High Speed Spray of Raw Material Powder

In the present embodiment, a thick magnet film is solidified and molded on a substrate by ultra high speed spray of the raw material powder. At that time, the space (distance) between the carrier gas accelerating part 17 (tip of the nozzle gun) and a surface of the substrate B disposed on the substrate holding part 19 is provided (arranged) to place a certain interval between them. By using a movable (scanning) nozzle gun as the carrier gas accelerating part 17, nozzle tip of the nozzle gun enables scanning at constant speed in a direction parallel (up and down direction and right and left direction) to the substrate B, and thus an even film can be formed on the entire region or any part (a certain region) of the substrate.

(2j-1) Scanning Speed of Gas Nozzle when Nozzle Gun is Used

When a movable (scanning) nozzle gun is used as the carrier gas accelerating part 17, scanning speed of the gas nozzle is not particularly limited, if it is within the range in which the working effect of the present embodiment is not inhibited. As described herein, the nozzle gun indicates a nozzle gun which is equipped with a nozzle to spray a carrier gas containing the raw material powder, and according to scanning the nozzle with respect to the substrate B, it enables a thick film with growth of a film. The scanning speed of such a gas nozzle is preferably in the range of 1 to 500 mm/s, more preferably 10 to 200 mm/s, and particularly preferably 50 to 100 mm/s. When the scanning speed of a gas nozzle is 1 mm/s or more, the heating region is uniform then a film with good adhesion property is obtained, and also film thickening can be achieved without lowering the production efficiency, and therefore favorable. Since the straightness increases as the scanning is slower, it is advantageous in that it is economically favorable as scattering of the raw material powder to a peripheral region of the substrate is prevented and also an even film thickness is achieved all over the substrate. When the scanning speed of a gas nozzle is 500 mm/s or less, unevenness caused by uneven spray can be suppressed and also, by excellent production efficiency (productivity), production cost can be reduced in accordance with large size production of a thick magnet film. It is also possible to form a film of magnet with very high film thickness by increasing pass number as the scanning speed increases, and it is also advantageous from the viewpoint of efficient forming of a thick magnet film with extremely large size. For such reasons, it is advantageous in terms of a technique fully applicable for a field which requires a very large and thick film, such as a motor for driving an electric vehicle.

(2j-2) Film Thickening Mode (1) Using Scanning Type Nozzle Gun=Multilayer Structure

For film thickening by using a movable (scanning) nozzle gun as the carrier gas accelerating part 17, by repeatedly scanning (moving or operating) several times in the aforementioned parallel (up and down direction and right and left direction), a desired thick film can be prepared. In other words, when a film thickness formed by single parallel (up and down direction and right and left direction) scanning (moving or operating) is 20 μm, fifty times of the parallel (up and down direction and right and left direction) scanning (moving or operating) can be performed over an entire surface of substrate for solidifying and molding of a 1000 μm thick magnet film.

When a bilayer structure of a rare earth magnet with different kind of a 1000 μm thick magnet film is prepared, twenty-five times of the parallel (up and down direction and right and left direction) scanning (moving or operating) are performed over an entire surface of substrate by using the raw material powder for the first layer. After that, by using the raw material powder for the second layer, twenty-five times of the parallel (up and down direction and right and left direction) scanning (moving or operating) are performed over an entire surface of substrate so that a thick magnet film with a bilayer structure in which each film has a thickness of 500 μm can be formed. Similarly, a thick magnet film with a multilayer structure of a rare earth magnet with different kind for each layer can be achieved while the thickness of each film is optionally modified.

(2j-3) Film Thickening Mode (2) Using Scanning Type Nozzle Gun=Fractionated Structure

To form a thick magnet film of a rare earth magnet with different kind between the right and left side of a substrate, two movable nozzle guns are used, for example, and by using one of the movable nozzle guns, fifty times of the parallel (up and down direction and right and left direction) scanning (moving or operating) are performed over the right half of a substrate surface. Simultaneously, by using the other movable nozzle gun, fifty times of the parallel (up and down direction and right and left direction) scanning (moving or operating) are performed over the left half of a substrate surface. By using different kind of the raw material powder (rare earth magnet) for each of the two movable nozzle guns, a thick magnet film of rare earth magnets with different kind between the right side and left side can be formed without unevenness or irregularities such as a step in a joint between the right and left. With an application of such operations, a thick magnet film in which plural thick magnet films of rare earth magnets with different kind are used in combination can be formed on a substrate. Specifically, when the substrate is divided into 16 sections, a thick magnet film with divided structure based on use of a rare earth magnet with different kind for each of the 16 divided (fractionated) sections can be formed. At that time, a thick magnet film of rare earth magnets with different types can be formed continuously. However, if required, it is also possible that individually separated 16 kinds of thick magnet films can be formed while a thick magnet film is not formed on the lattice line for having 16 divisions (fractions). In other words, a thick magnet film can be formed and arranged non-continuously, that is, in a so-called stepping stone manner. According to such a technique, the thick magnet film optimized to specific use can be suitably arranged only on the required areas.

(2j-4) Film Thickening Mode (3) Using Scanning Type Nozzle Gun=Multilayer+Fractionated Structure

It is also possible to form a thick magnet film of a rare earth magnet with three-dimensionally different kind by combining the aforementioned technique to form a thick magnet film with multilayer structure and the technique to form a thick magnet film with divided structure. It is also possible that the movable nozzle gun moves or operates also in a direction perpendicular to the whole surface of a substrate (front and rear direction). It is to correct even a slight amount of change in space (distance) between tip of the movable nozzle gun and the whole substrate surface, when a thick magnet film with a thickness of 2 mm (2000 μm) or so is formed, for example. Accordingly, the space (distance) between tip of the movable nozzle gun and the whole substrate surface can be always maintained at almost the same level, and thus it is favorable in that density in a thickness direction of the thick magnet film can be prepared to have further uniformity and high density.

(2j-5) Film Thickening Mode Using Scanning Type Substrate Holding Part

Contrary to the explanations given above, it is also possible that the space (distance) between tip of the fixed nozzle gun of the carrier gas accelerating part 17 and a surface of the substrate B on the movable (scanning) substrate holding part 19 is disposed (arranged) with a certain interval. In such a case, the movable substrate holding part 19 scans (moves or operates) at constant speed in a direction parallel (up and down direction and right and left direction) to the tip of the fixed nozzle gun of the carrier gas accelerating part 17. Accordingly, the substrate disposed on the movable substrate holding part 19 also moves in the same manner, and thus an even film can be formed on the entire region or any part (certain region) of the substrate with large area.

(2j-6) Film Thickening Mode (1) Using Scanning Type Substrate Holding Part=Multilayer Structure

For film thickening by using the movable substrate holding part 19, by repeatedly moving (operating) several times in the aforementioned parallel (up and down direction and right and left direction), a desired thick film can be prepared. In other words, when a film thickness formed by single parallel (up and down direction and right and left direction) scanning (moving or operating) is 20 μm, fifty times of the parallel (up and down direction and right and left direction) scanning (moving or operating) of the movable substrate holding part 19 can be performed with respect to the tip of the nozzle gun for solidifying and molding of a 1000 μm thick magnet film.

When a bilayer structure of rare earth magnets with different kind of a 1000 μm thick magnet film is prepared by using the movable substrate holding part 19, the same procedures as the movable nozzle gun can be performed. For example, twenty-five times of the parallel (up and down direction and right and left direction) scanning (moving or operating) are performed over an entire surface of substrate by using a raw material powder for the first layer. After that, by using a raw material powder for the second layer, twenty-five times of the parallel (up and down direction and right and left direction) scanning (moving or operating) are performed over an entire surface of substrate so that a thick magnet film with a bilayer structure in which each film has the thickness of 500 μm can be formed. Similarly, a thick magnet film with a multilayer structure of a rare earth magnet with different kind for each layer can be achieved while the thickness of each film is optionally modified.

(2j-7) Film Thickening Mode (2) Using Scanning Type Substrate Holding Part=Fractionated Structure

To form a thick magnet film of rare earth magnets with different kinds between the right side and left side of a substrate by using the movable substrate holding part 19, the same procedures as the case in which the carrier gas accelerating part 17 is a movable nozzle gun can be performed. For example, two fixed nozzle guns are used, for example, and by using one of the nozzle guns, fifty times of the parallel (up and down direction and right and left direction) scanning (moving or operating) of the movable substrate holding part 19 are performed to cover the right half of a substrate. Simultaneously, by using the other nozzle gun, fifty times of the parallel (up and down direction and right and left direction) scanning (moving or operating) of the movable substrate holding part 19 are performed to cover the left half of a substrate. At that time, by using different kind of the raw material powder (rare earth magnet) for each of the two fixed nozzle guns, a thick magnet film of rare earth magnets with different kinds between the right side and left side can be formed without unevenness or irregularities such as a step in a joint between the right and left. With an application of such operations, a thick magnet film in which plural thick magnet films of rare earth magnets with different kinds are used in combination can be formed on a substrate. Specifically, when the substrate is divided into 16 sections, a thick magnet film with divided structure by use of a rare earth magnet with different kind for each of the 16 divided (fractionated) sections can be formed. At that time, a thick magnet film of a rare earth magnet with different type can be formed continuously. However, if required, it is also possible that individually separated 16 kinds of thick magnet films can be formed while a thick magnet film is not formed on the lattice line for 16 divisions (fractions). In other words, a thick magnet film can be formed and arranged non-continuously, that is, in a so-called stepping stone manner. According to such a technique, the thick magnet film optimized to specific use can be suitably arranged only on the required areas.

(2j-8) Film Thickening Mode (3) Using Scanning Type Substrate Holding Part=Multilayer+Fractionated Structure

It is also possible to form a thick magnet film of rare earth magnets with three-dimensionally different kinds by combining the aforementioned technique to form a thick magnet film with multilayer structure and the technique to form a thick magnet film with divided structure. It is also possible that the movable substrate holding part 19 moves or operates also in a direction perpendicular to the tip of the nozzle gun (front and rear direction). It is to correct even a slight amount of change in space (distance) between tip of the fixed nozzle gun and the whole surface of the substrate B on the movable substrate holding part 19, when a thick magnet film with the thickness of 2 mm (2000 μm) or so is formed, for example. Accordingly, the space (distance) between tip of the fixed nozzle gun and the whole surface of the substrate B on the movable substrate holding part 19 can be always maintained at almost the same level, and thus it is favorable in that density in the thickness direction of the thick magnet film can be prepared to have further uniformity and high density.

(2j-9) Film Thickening Mode in which Scanning Type Nozzle Gun and Scanning Type Substrate Holding Part are Used in Combination

It is also possible that the nozzle gun of the carrier gas accelerating part 17 and the substrate holding part 19, both in movable (scanning) type, are used in combination. This is the same principles as an ink-jet printer in which a nozzle gun (=ink-jet part) of the carrier gas accelerating part 17 on one side is scanned (moved or operated) only in the right and left direction: X axis direction of the substrate surface (right and left direction: X axis direction, and up and down direction: Y axis direction). On the other hand, the substrate holding part 19 (=print paper) on the other side is scanned (moved or operated) only in the up and down direction: Y axis direction of the substrate surface. By the constitution (structure) in which the nozzle gun of the carrier gas accelerating part 17 and the substrate holding part 19 are moved in associated way (synchronously) with each other, it is favorable in that a desired thick magnet film can be obtained by relatively simple operations and control. Meanwhile, with those constitutions, the aforementioned thick magnet film having a multilayer structure can be formed and also a thick magnet film with a divided structure can be obtained. It is also possible to form a thick magnet film of rare earth magnets with three-dimensionally different kinds by combining the aforementioned technique to form a thick magnet film with multilayer structure and the technique to form a thick magnet film with divided structured.

The above corresponds to explanations of the second embodiment of the present invention, and in other words, it can be a method for producing a thick magnet film including the following steps (1) and (2). Specifically, it includes a spraying step (1) including spraying a raw material powder with a high speed carrier gas in an accelerated state after mixing a carrier gas and the raw material powder, and a solidifying and molding step (2) including depositing the sprayed raw material powder on a substrate to solidify and mold. In addition to them, the present embodiment relates to a method of producing a thick magnet film characterized in that the raw material powder is a rare earth magnet powder, a temperature of the high speed carrier gas at the spraying step (1) is lower than the particle growth temperature of crystalline particles of the rare earth magnet powder, and the solidifying and molding step (2) is performed under atmospheric pressure. Herein below, explanations are given for those requirements.

The spraying step (1) including spraying raw material powder with high speed carrier gas in an accelerated state after mixing carrier gas and raw material powder

In the spraying step of the present embodiment, the raw material powder is sprayed with a high speed carrier gas in an accelerated state after mixing a carrier gas and the raw material powder. With regard to the aforementioned cold spray apparatus, it is preferable that the raw material powder is sprayed with a high speed carrier gas, which is in an accelerated state after mixing a carrier gas and the raw material powder (=the raw material powder is neither melted nor gasified but controlled to have pre-determined temperature, pressure, and speed). For spraying, the raw material powder is sprayed with a high speed carrier gas, without melting of gasification, with the carrier gas at ultra high speed from tip of a spray nozzle of a nozzle gun toward a substrate while the raw material powder remains in a solid phase state. Since the spraying step of the present embodiment is the same as those explained in (1) overview and (2a) to (2i) of the embodiment (B), no further explanations are given herein.

The solidifying and molding step (2) for solidifying and molding by depositing sprayed raw material powder on substrate

The solidifying and molding step of the present embodiment is to solidify and mold by depositing on a substrate the raw material powder which has been sprayed in the above spraying step (1). Preferably, the raw material powder sprayed in the above spraying step (1), remaining in a solid phase state, is collided•adhered to a substrate at ultra high speed with a carrier gas to form a film with high density, and by repeating those operations, the raw material powder is deposited on the substrate, and as a result, a thick deposit film with high density and excellent magnetic properties are solidified and molded. Accordingly, a thick magnet film with high density and excellent magnetic properties can be obtained. Since the solidifying and molding step of the present embodiment is the same as those explained in (1) overview and (2j) of the embodiment (B), no further explanations are given herein.

(3) Raw Material Powder, Temperature of Carrier Gas, and Under Atmospheric Pressure

As for the material powder used in the present embodiment, temperature of the high speed carrier gas at the aforementioned spraying step (1), and operating the solidifying and molding step (2) under atmospheric pressure, since they are the same as those explained in detail in (2e), (2h-2), (2i) or the like of the embodiment (B), no further explanations are given herein.

### (B1) Method for Producing Thick Magnet Film (Variation Example 1 of the Second Embodiment)

Like the second embodiment, the variation example 1 of the second embodiment (herein below, also abbreviated as the present variation example 1) also uses the method for producing a thick magnet film using a technique of forming film from powder by deposition of particles.

### Variation of the Second Embodiment

The first example is, specifically, a method for producing a thick magnet film including the following steps (1) and (2). Specifically, it includes a spraying step (1) including spraying a raw material powder with a high speed carrier gas in an accelerated state after mixing a carrier gas and the raw material powder, and a solidifying and molding step (2) including depositing the sprayed raw material powder on a substrate to solidify and mold. In addition to them, the present variation example 1 relates to a method of producing a thick magnet film characterized in that the raw material powder is a rare earth magnet powder, gas pressure at the spraying step (1) is more than 0.5 MPa, and the solidifying and molding step (2) is performed under atmospheric pressure. The present variation example 1 is, in other words, a method for producing a thick magnet film which uses an apparatus having a high pressure carrier gas generating part, a heater to heat a carrier gas, a raw material powder supplying part, a carrier gas accelerating part, and a substrate holding part. More specifically, primary carrier gas passed through the high pressure carrier gas generating part and the heater to heat a carrier gas and the raw material introducing gas containing a raw material powder from the raw material powder supplying part are introduced into the carrier gas accelerating part followed by mixing and acceleration, and the resulting high speed carrier gas is sprayed under atmospheric pressure. Thus, it is a method for producing a thick magnet film in which the raw material powder is deposited on a substrate on the substrate holding part by spraying of the high speed carrier gas for solidifying and molding. In addition to them, the present variation example 1 relates to a method of producing a thick magnet film characterized in that the raw material powder is rare earth magnet powder and the solidifying and molding is performed by spraying under a gas pressure of more than 0.5 MPa. According to the variation example 1, a method for producing a magnet satisfying at once the film thickening, high density and improving magnetic properties (in particular, residual magnetic flux density) can be provided without lowering the magnetic properties of magnet powder, and thus a desired thick magnet film (bulk molded product) can be obtained (compare Examples 1 to 9 to Comparative Examples 1 and 3 for reference). As a characteristic, which is based on the cold spray method, not found in the AD method of a related art (1) high density can be achieved by a high particle speed, and thus the magnetic properties (∝ density) are improved. (2) Particles with larger size can be sprayed. Thus, an occurrence of local density deviation due to non-uniformity in the thick magnet film, which is caused by aggregated secondary particles (without high density) as a result of micronization of the primary particles, and also deterioration in magnetic properties can be effectively inhibited. As optimization (optimum arrangement) of particles and voids can be achieved by using particles with optimum size, desired ratio (%) with respect to theoretical density can be achieved. (3) An overwhelmingly high film growth speed can be achieved. As a result, a bulk product is obtained due to film thickening. Based on the properties that are not found in the AD method of a related art, as an effect of the cold spray method, (1) residual magnetization (ratio of bulking/properties of raw material (%)=residual magnetic flux density B (%)) is improved due to a high density (see, Tables 1 and 2 and FIG. 3). (2) The high density is reflected in hardness (Hv) (compare the literature values according to AD method of Tables 1 and 2 and FIG. 4 to Examples 1 to 6 for reference).

Thus, in the variation example 1, the requirement “temperature of the carrier gas at the spraying step is lower than the particle growth temperature of crystalline particles of the rare earth magnet” of the second embodiment is modified to the requirement “gas pressure at the spraying step is more than 0.5 MPa”. Accordingly, as other constitutional requirements are the same as those explained in detail for the second embodiment, no further explanations are given herein. Thus, herein below, the modified requirements are explained in detail.

(2k) Gas Pressure

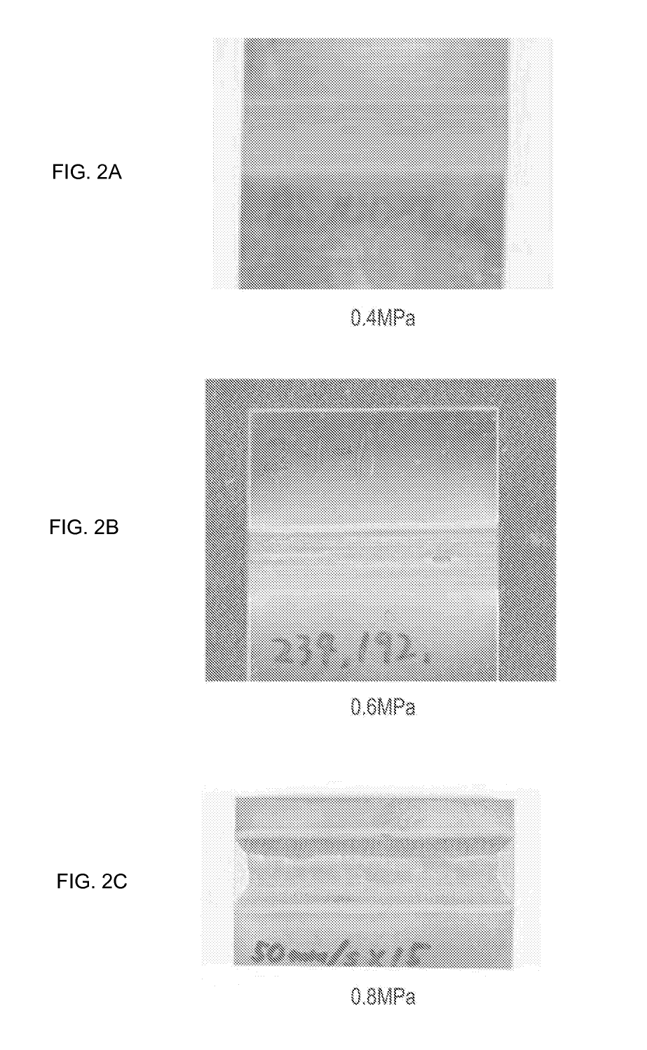

The variation example 1 of the present embodiment is characterized in that the solidifying and molding is achieved by spraying at a gas pressure of more than 0.5 MPa. As described herein, the gas pressure indicates a pressure at spraying step before opening in the atmosphere, and it can be measured with the aforementioned pressure sensor 8a. The carrier gas pressure is in balance with a temperature of the carrier gas. When the pressure is excessively low, deposition cannot be made by collision and adhesion to the substrate even when the temperature is increased as much as possible. Upper limit of the gas pressure varies depending on compatibility with the substrate B. Even under the same pressure, it may function to shave the substrate, to cause bouncing on the substrate, or to yield desirable deposition on a substrate. For example, even under the gas pressure at which collision and adhesion to the substrate is made and desirable deposition on the substrate is made when a Cu plate is used as a substrate, if an A1 plate is used instead as a substrate, it may function to shave the substrate. From this point of view, although the gas pressure cannot be defined uniquely, the pressure of the carrier gas is sufficiently more than 0.5 MPa, preferably 0.6 MPa or more, more preferably in the range of 0.6 to 5 MPa, and particularly preferably 0.8 to 3 MPa. Even if the pressure is not within the range, when no adverse effect is exhibited on the working effect of the variation example 1 and the working effect of the variation example 1 is suitably exhibited, it can be included in the scope of the variation example 1. Pressure of more than 0.5 MPa is preferable in that a thick magnet film can be obtained according to growth of the film with high density and excellent magnetic properties with high density (residual magnetic flux density and hardness Hv) can be obtained without causing a reduction in particle speed at ultra high speed. In other words, although it may vary depending on type of the rate earth magnet, once the pressure is 0.4 MPa or less for Sm—Fe—N alloy base (see, Table 1) or 0.4 MPa or less for Nd—Fe—B alloy base (see, Table 2), the reduction in particle speed is significant then the film growth may be difficult (see, FIG. 2).

The reason of the carrier gas pressure of more than 0.5 MPa, and preferably equal to or more than 0.6 MPa is that, at the pressure of 0.5 MPa or less, the reduction in particle speed is significant then the film growth may be difficult. FIG. 2 is a drawing illustrating the overall view (appearance) of the film when the gas power is changed. According to FIG. 2, at the gas power of 0.4 MPa, a state of no film formed on a center part of the substrate is observed, and thus it is found that the film is not formed due to a reduced particle speed. On the other hand, at the gas powder of 0.6 MPa and 0.8 MPa, a state of a film clearly formed on a center part of the substrate is exhibited.

(3′) Raw Material Powder, Gas Pressure, and Under Atmospheric Pressure

As for the material powder used in the variation example 1 of the present embodiment, the gas pressure at the aforementioned spraying step (1), and operating the solidifying and molding step (2) under atmospheric pressure, since they are the same as those explained in detail in (2e), (2h-2), (2k) or the like of the present embodiment (B) and the variation example 1 thereof, no further explanations are given herein.

### (B2) Method for Producing Thick Magnet Film (Variation Example 2 of the Second Embodiment)

Like the second embodiment, the variation example 2 of the second embodiment (herein below, also abbreviated as the present variation example 2) also uses the method for producing a thick magnet film using a technique of forming film from powder by deposition of particles.

The variation example 2 of the second embodiment is, specifically, a method for producing a thick magnet film including the following steps (1) and (2). Specifically, it includes a spraying step (1) including spraying a raw material powder with a high speed carrier gas in an accelerated state after mixing a carrier gas and the raw material powder, and a solidifying and molding step (2) including depositing the sprayed raw material powder on a substrate for solidifying and molding. In addition to them, the present variation example 2 relates to a method of producing a thick magnet film characterized in that the raw material powder is a rare earth magnet powder, the temperature of the carrier gas at the spraying step (1) is lower than the particle growth temperature of the crystalline particles of the rare earth magnet, and the gas pressure at the spraying step (1) is more than 0.5 MPa. It is also a method for forming a thick magnet film in which the solidifying and molding step (2) is performed under atmospheric pressure. The present variation example 2 is, in other words, a method for producing a thick magnet film which uses an apparatus having a high pressure carrier gas generating part, a heater to heat a carrier gas, a raw material powder supplying part, a carrier gas accelerating part, and a substrate holding part. More specifically, primary carrier gas passed through the high pressure carrier gas generating part and the heater to heat a carrier gas and raw material introducing gas containing raw material powder from the raw material powder supplying part are added to the carrier gas accelerating part followed by mixing and acceleration, and the resulting high speed carrier gas is sprayed under atmospheric pressure. Thus, it is a method for producing a thick magnet film in which the raw material powder is deposited on a substrate on the substrate holding part by spraying of the high speed carrier gas for solidifying and molding. In addition to them, the present variation example 2 relates to a method of producing a thick magnet film characterized in that the raw material powder is a rare earth magnet powder, the temperature of the carrier gas is lower than the particle growth temperature of the crystalline particles of the rare earth magnet, and the solidifying and molding is performed by spraying under gas pressure of more than 0.5 MPa. According to the variation example 2, a method to produce a magnet satisfying at once the film thickening, high density and improving magnetic properties (in particular, residual magnetic flux density) can be provided without lowering the magnetic properties of magnet powder, and thus a desired thick magnet film (bulk molded product) can be obtained (compare Examples 1 to 9 to Comparative Examples 1 to 4 for reference). As a characteristic, which is based on the cold spray method, not found in the AD method of a related art (1) high density can be achieved by having high particle speed, and thus the magnetic properties (∝ density) are improved. (2) Particles with larger size can be sprayed. Thus, an occurrence of local density deviation due to non-uniformity in the thick magnet film, which is caused by aggregated secondary particles (without high density) as a result of micronization of the primary particles, and also deterioration in magnetic properties can be effectively inhibited. As optimization (optimum arrangement) of particles and voids can be achieved by using particles with an optimum size, desired ratio (%) with respect to theoretical density can be achieved. (3) An overwhelmingly high film growth speed can be achieved. As a result, a bulk product is obtained due to film thickening. Based on the properties that are not found in the AD method of a related art, as an effect of the cold spray method, (1) residual magnetization (ratio of bulking/properties of raw material (%)=residual magnetic flux density B (%)) is improved due to high density (see, Tables 1 and 2 and FIG. 3). (2) High density is reflected in hardness (Hv) (compare the literature values according to AD method of Tables 1 and 2 and FIG. 4 to Examples 1 to 6 for reference).

Thus, in the variation example 2, the requirement of the variation example 1 is added to the requirement “temperature of the high speed carrier gas at the spraying step is lower than the particle growth temperature of crystalline particles of the rare earth magnet powder” of the second embodiment. In other words, in the variation example 2, the requirement is changed as follows; “the temperature of the high speed carrier gas at the spraying step is lower than the particle growth temperature of the crystalline particles of the rare earth magnet, and a gas pressure at the spraying step is more than 0.5 MPa”. Accordingly, as all constitutional requirements are the same as those explained in detail for the second embodiment and the variation example 1 thereof, no further explanations are given herein.

### (B3) with Regard to the Characteristics of the Second Embodiment (Including the Variation Example)

As described above, the present embodiment (including the variation example) uses the cold spray method, that is, a method to form a film (film formation) in which the raw material powder is added without being melted or gasified to a high speed carrier gas so that the raw material powder remained in a solid phase state is collided•adhered, together with the carrier gas, to a substrate at ultra high speed. Compared to thermal spray method or plasma thermal spray method of a related art, the cold spray method allows processing at a temperature lower than the melting point of materials, and thus it is classified as a low temperature process such as aerosol deposition (AD) method. However, unlike the AD method in which gas accelerating method is based on lowering the pressure in vacuum chamber, the cold spray method is characterized in that the acceleration is made by heating a carrier gas. Thus, while particle speed faster than the AD method is obtained, it is also characterized in that the raw material powder is inevitably heated to a temperature of equal to or higher than room temperature. In addition, since further acceleration of particle speed can be obtained as the carrier gas temperature increases, compared to the temperature for thermal spray, which is generally higher than 1000° C., it could be a solidifying and molding technique with a low temperature range. However, there is a problem that it is still several hundred degrees. For such reasons, although the cold spray method is used as a method to coat metal having high melting point, a hard material, or ceramics, there is an advantage that a change in the characteristics is small in the original temperature range for the cold spray method. However, for a material exhibiting a great change in characteristics depending on heat of several hundred degrees such as the magnet powder for a bond magnet used for the present embodiment (including the variation example), an operation in further lower temperature is necessary. Accordingly, when spray is performed after lowering the temperature of carrier gas, collision speed of particles to a substrate is lowered, and thus a problem that the film growth does not occur because they are not adhered onto the substrate. On the other hand, when the temperature of carrier gas is increased, the magnetic properties deteriorate and also hard and brittle materials such as a magnet material are excessively accelerated and the magnet particles function as abrasives, and as a result, there is a problem that the substrate is shaved and no film is formed as a magnet. As such, we tried to improve those problems. As a result, it was found that, in a raw material powder of a rare earth magnet, by the carrier gas temperature lower than the particle growth temperature of crystalline particles of a rare earth magnet, deterioration of magnetic properties can be prevented, and according to solidifying and molding by spraying at a gas pressure of more than 0.5 MPa, and preferably equal to or more than 0.6 MPa, the film growth can be achieved.

### (C) Magnet Motor (Third Embodiment)

The magnet motor of the present embodiment is characterized in that it is obtained by using at least one thick magnet film obtained by selection from a group consisting of a thick magnet film described in the first embodiment and a thick magnet film obtained by the production method described in the second embodiment (including the variation example). Specifically, in the magnet motor of the present embodiment, only one kind of the thick magnet film of the first and the second embodiments can be used, or two or more kinds of them can be used in combination. Since the magnet motor of the present embodiment is a magnet motor (for example, for small-sized home appliance, surface magnet type, and the like) characterized by using at least one kind of a magnet (thick film) of the first and the second embodiments, it is favorable in that the equivalent characteristics can be obtained from a light, small-sized, and high performance system.

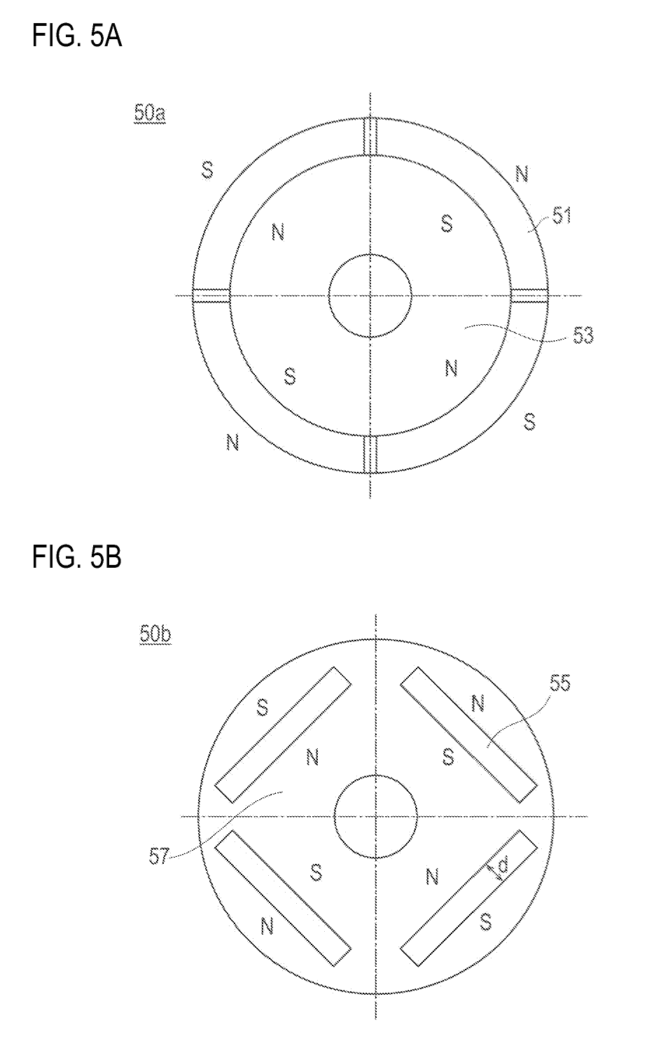

FIG. 5a is a schematic cross-sectional view illustrating diagrammatically a rotor structure of a surface permanent magnet synchronous motor (SMP or SPMSM). FIG. 5b is a schematic cross-sectional view illustrating diagrammatically a rotor structure of an internal permanent magnet synchronous motor (IMP or IPMSM). In the surface permanent magnet synchronous motor 50a illustrated in FIG. 5a, at least one kind of the magnet (thick film) 51 of the first and the second embodiments is directly solidified and molded (or attached) on a surface of the rotor 53 for a surface permanent magnet synchronous motor. In the surface permanent magnet synchronous motor 50a, as described in the first and the second embodiments, by using the rotor 53 as a substrate, the raw material powder is directly sprayed on the rotor 53 and adhered and deposited for solidifying and molding to form the magnet (thick film) 51 on the surface permanent magnet synchronous motor 50a. By magnetization of the magnet (thick film) 51, the surface permanent magnet synchronous motor 50a can be obtained. That could be better than the internal permanent magnet synchronous motor 50b. In case of direct solidifying and molding, in particular, it is favorable in that the magnet (thick film) 51 is not peeled from the rotor 53 even under a high speed rotation with centrifugal force, and thus it can be easily used. Meanwhile, in the internal permanent magnet synchronous motor 50b illustrated in FIG. 5b, at least one kind of the magnet (thick film) 55 of the first and the second embodiments is installed under pressure (inserted) to an internal groove formed on the rotor 57 for an internal permanent magnet synchronous motor followed by fixing. In the internal permanent magnet synchronous motor 50b, as explained in the first and the second embodiments, a substrate having the same surface shape as the internal groove (illustrated figure) is used, the raw material powder is sprayed on a substrate until the powder has the same thickness d as the internal groove, and, the magnet (thick film) 55 is obtained by adhesion and deposition on a substrate solidifying and molding. Alternatively, a substrate having the same surface shape as the internal groove (illustrated figure) is used, the raw material powder is sprayed on a substrate until the powder has the thickness d which is 1/10 of the internal groove, and according to, 10 sets of the magnet (thick film) 55 are produced by adhesion and deposition on a substrate, solidification and mold. At that time, the substrate and the magnets (thick films) 55, 55a are closely adhered (integrated). Next, the magnets (thick films) 55, 55a are removed from the substrate surface (which has been adhered with an extremely thin metal foil easily soluble in a solvent) is peeled by using a suitable solvent (a solvent dissolving only the metal foil on substrate) or peeled (removed) by applying physical stress to obtain only the magnets (thick films) 55, 55a. Next, the magnets (thick films) 55, 55a are magnetized and, ten pieces of the magnet (thick film) 55a are overlaid so that the magnet 55a has desired thickness d. After that, by installing (inserting) under pressure the magnet (thick film) 55 or 55a (10 pieces of laminates) to the internal groove of the rotor 57, the internal permanent magnet synchronous motor 50b can be obtained. In such a case, the magnets (thick films) 55, 55a in a plate shape is favorable in that solidifying and molding of the magnets (thick films) 55, 55a is easier than the surface permanent magnet synchronous motor 50a which needs solidifying and molding of a magnet on a curved surface. Meanwhile, the present embodiment is not limited to specific motor described above, and it can be applied to a field of broad range. In other words, it is sufficient to have a shape corresponding to various applications in a very broad range in which a rare earth magnet is used, for example, consumer electronics field such as a motor to drive rotary head such as capstan motor of audio equipment, speaker, headphone, a motor for picking up CD, or winding in a camera, actuator to focus, or video equipment, motor to zoom, motor to focus, capstan motor, optical pickup for DVD or Blu-ray, air conditioning compressor, fan motor for outdoor unit, or a motor for electric shave; peripheral equipment for a computer and OA equipment such as voice coil motor, spindle motor, optical pickup for CD-ROM and CD-R, stepping motor, plotter, actuator for printer, dot printer print head, or rotating sensor for copying machine; precision devices in the field of measurement, communications, and others such as stepping motor for watch, various meter, pager, vibration motor for cellular phone (including cellular information terminals), motor to drive recorder pen, accelerator, undulator for light radiation, polarized magnet, ion source, various plasma sources in a device for manufacturing semiconductor, electronic polarization, or magnetic inspection bias; medical fields such as permanent magnetic type MRI, electrocardiography device, electroencephalography device, dental drill motor, magnet to fix teeth, or magnetic necklace; FA fields such as AC servo motor, synchronous motor, brake, clutch, torque coupler, linear motor for return, or lead switch; and electric components and devices of an automobile such as retarder, ignition coil transformer, ABS sensor, detection sensor for rotation or position, sensor for suspension control, door lock actuator, ISCV actuator, motor for driving electric vehicle, motor to drive hybrid vehicle, motor to drive fuel cell vehicle, blushless DC motor, AC servo motor, AC induction motor, power steering, optical pickup for car navigation. However, the use in which the rare earth magnet of the present embodiment is used is not limited at all to the aforementioned extremely small area of products (parts), and it is needless to say that it can be widely used for general applications in which the rare earth magnet is currently used. It is also possible that, by using a substrate as a releasing material and taking out only a thick magnet film which is formed on a substrate and then peeled (removed) from the surface of a substrate, it can be used for various applications. For such a case, it is sufficient that the shape of a substrate is prepared to have a shape applicable for the use, and examples thereof include a plate (disc) shape of polygon (triangle, square, trapezoid, hexagon, circular shape or the like), a wave plate polygon (triangle, square, trapezoid, hexagon, and circular shape), a donut shape, or the like, but not particularly limited.

### EXAMPLES

Herein below, the present invention is explained in greater detail by describing specific examples of the present invention. However, the technical scope of the present invention is not limited to the following examples.

### Examples 1 to 6 and Comparative Example 1 and 2

A thick magnet film was formed by the cold spray method which uses the cold spray apparatus 10 illustrated in FIG. 1.

As the substrate B, a Cu substrate having width of 30 mm, length of 50 mm, and thickness of 1 mm was prepared. As the substrate holding part 19, a stone slab was prepared, and as the carrier gas accelerating part 17, a nozzle gun was prepared. Surface of the Cu substrate was fixed on the stone slab such that the substrate was at a distance of 10 mm from nozzle tip of a nozzle gun (four corners of the substrate were fixed), and then (magnet) raw material powder was sprayed toward the Cu substrate by the cold spray method to grow a magnet film and solidify and mold. As a result, a thick magnet film was obtained.

As for the (magnet) raw material powder, magnet powder for Sm₂Fe₁₄N₃ alloy-based bond magnet was used. With regard to the particle diameter of the (magnet) raw material powder, it was mainly the particle diameter of 5 μm or less as determined by SEM (scanning type electron microscope). In addition, as a result of particle size distribution analysis, the average particle diameter was found to be 3 μm.

As for the carrier gas used for the cold spray method, low temperature (room temperature) He gas or N₂ gas, which has been generated from a high pressure He bombe or a high pressure nitrogen bombe as the high pressure carrier gas generating part 11, was used (more specifically, see Table 1). The low temperature carrier gas generated in the high pressure carrier gas generating part 11 was heated by the heater to heat a carrier gas 13. The temperature (gas temperature) of the heated primary carrier gas after heating by the heater to heat a carrier gas 13 was maintained at constant temperature of 1000° C. As for the heater to heat a carrier gas 13, kanthal wire as a heating resistor was used. A rotary stirrer to ensure powder fluidity was installed inside a small-size stainless hopper as the raw material powder supplying part 15, and the following process was used: the raw material powder deposited on a mesh, which is installed on bottom part of the hopper, was filtered through the mesh while it was stirred by the stirrer. Via the raw material powder supplying part 15, the raw material introducing gas obtained by mixing the raw material powder with the same kind of gas as the carrier gas was introduced into the nozzle gun. The addition amount of the raw material powder was in the range of 8.5 to 10 g/min (see Table 1 below).

Temperature and pressure of the carrier gas were measured by the temperature sensor 18b and the pressure sensor 18a in the carrier gas accelerating part (nozzle gun) 17, after the primary carrier gas and the raw material introducing gas were mixed with each other.

The carrier gas accelerating part 17 (nozzle gun) was equipped with a nozzle to spray the carrier gas containing the raw material powder. By scanning the nozzle with respect to the Cu substrate, the film was grown to obtain a thick film (see, FIG. 2). By repeated scanning of the gas nozzle of the carrier gas accelerating part 17 (nozzle gun) in the length direction of the Cu substrate, film thickening was achieved (see, the thick magnet film of FIG. 2 exhibiting 0.4 MPa (film is not formed)→0.6 MPa→0.8 MPa).

With a staggering of 0.5 mm in width direction per one scanning in length direction, a magnet film with width of 10 mm was produced. Pass number was overlaid until the thickness reached 0.5 mm to 1.5 mm from the original thickness of the substrate B.

In Example 1, a thick magnet film was obtained by solidifying and molding with the gas pressure of 0.8 MPa, the carrier gas temperature of 270° C., and the scanning speed of 50 mm/s.

After polishing the surface, the obtained magnet (thick film) was subjected to the hardness (Hv) measurement by using a micro surface hardness tester while the magnet was still attached to the Cu substrate. Separately, a sample of 5 mm size (both in length and width) was cut and the magneticity measurement was performed for each Cu substrate by using a vibrating sample magnetometer (VSM). Correction of demagnetizing field was performed by calculating a thickness obtained by excluding the substrate thickness from the obtained film thickness.

Regarding the density, in case of a thin film, the adhesion amount of the raw material powder was obtained from the weight after surface polishing by measuring in advance the weight of the substrate B. The density could be obtained by using previously determined film thickness. In case of a thick film of 1 mm or more, the Cu substrate was removed by fraise processing, and then the measurement was made based on Archimedes's method. As described herein, the theoretical density indicates the density when the main magnet phase in the raw material powder has a lattice constant obtained by X ray analysis and it occupies to 100% volume of a thick magnet film (molded magnet product).

The lattice constant of Sm₂Fe₁₄Nₓ(x=2 to 3) compound used was measured by X ray analysis and the theoretical density was calculated to be 7.67 g/cm³. By using that value, conversion into the ratio (%) with respect to the theoretical density was made.

With regard to “Residual magnetic flux density (B) (=residual magnetization (ratio of bulking/properties of raw material) (%)”, the value after the solidifying and molding was evaluated when the value of the raw material powder was 100%. Values of the residual magnetic flux density (B) and hardness (Hv) were compared to the values reported not only in Comparative Examples 1 and 2 but also by AD method (see Table 1 and FIGS. 3 and 4).

The decomposition temperature was determined for the raw magnetic powder of Sm₂Fe₁₄Nₓ(x=2 to 3) (raw material powder) based on DSC (differential scanning calorimetry) analysis. With the raw material powder used in the case, the decomposition occurred at 450° C. or higher.

Further, with regard to Examples 2 to 6 and Comparative Examples 1 and 2, each test was performed by varying the gas pressure, carrier gas temperature, scanning speed, and supply amount of (raw material) powder of Example 1 as listed in the following Table 1. The obtained results are summarized in Table 1 and also illustrated in FIGS. 3 and 4.

TABLE 1

| | | Gas | Gas | | Supply amount of | | | | |
|---|---|---|---|---|---|---|---|---|---|
| | Gas | pressure | temperature | Scanning speed | powder | Density | | B | |
| | type | MPa | ° C. | mm/s | g/min | g/cm³ | % | % | HV |
| Example 1 | He | 0.8 | 270 | 50 | 8.5 | 7.1 | 93 | 88.6 | 812 |
| Example 2 | He | 0.8 | 320 | 100 | 8.5 | 7.2 | 94 | 93.2 | 828 |
| Example 3 | He | 1.2 | 350 | 50 | 9.0 | 7.2 | 94 | 91.1 | 822 |
| Example 4 | He | 0.6 | 250 | 100 | 9.5 | 7.1 | 93 | 87.3 | 821 |
| Example 5 | He | 0.6 | 200 | 50 | 10.0 | 6.8 | 89 | 78.0 | 788 |
| Example 6 | N₂ | 2.8 | 300 | 50 | 9.0 | 7.2 | 94 | 91.1 | 803 |
| Comparative | He | 0.4 | 350 | 50 | 10.0 | — | — | — | — |
| Example 1 | | | | | | | | | |
| Comparative | He | 0.8 | 490 | 100 | 10.0 | 7.4 | 97 | 43.0 | 835 |
| Example 2 | | | | | | | | | |

From the result of Table 1, it was found that a film was not obtained in Comparative Example 1 because the gas pressure was low. In Comparative Example 2, the gas temperature was excessively high (it was 490° C., which is higher than 450° C. as decomposition temperature of rare earth magnet, nitride=raw material powder) then sufficient residual magnetization (B) was not obtained (see FIG. 3).

### Examples 7 to 9 and Comparative Examples 3 and 4

Next, a raw material magnet powder for a NdFeB bond magnet was prepared. As for the preparation method, HDDR treatment (Hydrogenation Decomposition Desorption Recombination: hydrogen de-homogenization+dehydrogenation treatment) was used.

Specifically, an ingot having composition as follows—Nd: 12.6%, Co: 17.4%, B: 6.5%, Ga: 0.3%, Al: 0.5%, Zr: 0.1%, and Fe: balance—was prepared and it was homogenized by maintaining it for 20 hours at 1120° C. Further, the homogenized ingot was maintained in hydrogen atmosphere after raising the temperature from room temperature to 500° C., and it was maintained again after raising the temperature to 850° C.

After subsequently maintaining it in vacuum at 850° C., it was cooled to obtain an alloy which had recrystallization structure (crystalline particle) with fine ferromagnetic phase. The alloy was turned into powder under Ar atmosphere by using a crude crusher and brown mill to obtain the rare earth magnet powder with average particle diameter of 200 μm. By further pulverization using a jet mill, a magnet powder with average particle diameter of 4 μm was obtained.

By using the obtained magnet powder as a raw material powder, a thick magnet film was produced by the same solidifying and molding as Example 1 based on the cold spray method which used the cold spray apparatus 10 illustrated in FIG. 1. Conditions for the solidifying and molding, density, and magnetic properties are summarized in Table 2 and also illustrated in FIGS. 3 and 4. From the X ray analysis, the theoretical density was calculated to be 7.60 g/cm³. By using that value, conversion into the ratio (%) with respect to the theoretical density was made.

TABLE 2

| | | Gas | Gas | Scanning | Supply amount of | | | | |
|---|---|---|---|---|---|---|---|---|---|
| | Gas | pressure | temperature | speed | powder | Density | | B | |
| | type | MPa | ° C. | mm/s | g/min | g/cm³ | % | % | HV |
| Example 7 | N₂ | 2.8 | 550 | 50 | 8.5 | 7.1 | 93 | 87.2 | 621 |
| Example 8 | N₂ | 1.7 | 700 | 50 | 9.0 | 7.0 | 92 | 88.9 | 595 |
| Example 9 | N₂ | 3.1 | 450 | 50 | 9.0 | 7.1 | 93 | 92.1 | 605 |
| Comparative | N₂ | 0.5 | 550 | 50 | 8.0 | — | — | — | — |
| Example 3 | | | | | | | | | |
| Comparative | N₂ | 2.0 | 780 | 50 | 9.0 | 7.2 | 95 | 41.0 | 580 |
| Example 4 | | | | | | | | | |

A film was not obtained in Comparative Example 3 as the gas pressure was low. In Comparative Example 4, even though the heat resistant property was improved by using N₂ as gas species, since the gas temperature was excessively high (it was 780° C., which was higher than 740° C. of particle growth temperature of the crystalline particle of the rare earth magnet (raw material powder)) then sufficient residual magnetization (residual magnetic flux density (B)) was not obtained (see FIG. 3).

The raw material powder (raw magnetic powder) was subjected separately to a heating treatment in vacuum with soaking time of 1 minute to evaluate the magnetic properties. It was found that the magnetic properties were deteriorated at the temperature of 740° C. or higher. As a result of analyzing the crystalline particles by X ray analysis, it was found that the deterioration of the magnetic properties was caused by coarsification of crystalline particles.

It was recognized from the results of Tables 1 and 2 and FIGS. 3 and 4 that, according to Examples 1 to 9, a thick magnet film excellent in all of the magnetic properties, in particular, density, residual magnetization (residual magnetic flux density (B)), and hardness (Hv) with respect to the literature values of the AD method of a related art and Comparative Examples 1 to 4 is obtained.

1. A thick magnet film comprising:
a rare earth magnet phase represented by a formula R-M-X, wherein R includes at least one of Nd and Sm, M includes at least one of Fe and Co, and X includes at least one of N and B,
the thick magnet film having a density of equal to or more than 80% but less than 95% of a theoretical density when the R has Nd as a main component, and having a density of equal to or more than 80% but less than 97% of the theoretical density when the R has Sm as the main component, and wherein the thick magnet film does not have a binder material.

2. The thick magnet film according to claim 1, wherein the rare earth magnet phase is rare earth magnet powder in which R is a nitrogen compound including Sm and Fe as a main component.

3. The thick magnet film according to claim 1, wherein a thickness of the thick magnet film is 200 to 3000 μm.

4. The thick magnet film according to claim 1, wherein the thick magnet film is obtained by a process of film forming from powder, which forms a film by depositing particles.

5. A method for producing a thick magnet film, the method comprising:
spraying a raw material powder with a high speed carrier gas in an accelerated state after mixing a carrier gas and the raw material powder;
depositing the sprayed raw material powder on a substrate for solidifying and molding,
wherein the raw material powder is a rare earth magnet powder having no binder material and a temperature of the high speed carrier gas at the spraying step is lower than a particle growth temperature of crystalline particles of the rare earth magnet; and
solidifying and molding the substrate with the deposited raw material powder under atmospheric pressure.

6. A method for producing a thick magnet film, the method comprising:
spraying a raw material powder with high speed carrier gas in an accelerated state after mixing carrier gas and the raw material powder;
depositing the sprayed raw material powder on a substrate for solidifying and molding,
wherein the raw material powder is a rare earth magnet powder having no binder material and a gas pressure at the spraying step is more than 0.5 MPa; and
solidifying and molding the substrate with the deposited raw material powder under atmospheric pressure.

7. The method for producing a thick magnet film according to claim 6, wherein a temperature of the high speed carrier gas during spraying is lower than a particle growth temperature of crystalline particles of the rare earth magnet.

8. The method for producing a thick magnet film according to claim 5, the method further comprising:
heating the carrier gas before mixing the carrier gas with the raw material powder.

9. The method for producing a thick magnet film according to claim 5, wherein the raw material powder is at least one selected from the group consisting of:
magnet powder for constituting a rare earth magnet phase represented by the formula (1) R-M-X, wherein R includes at least one of Nd and Sm, M includes at least one of Fe and Co, and X includes at least one of N and B; and
magnet powder as a part of constitutional components of a rare earth magnet phase represented by a formula (2) R-M, wherein R and X are as defined in the formula (1) when X in the formula (1) is N.

10. The method for producing a thick magnet film according to claim 5, wherein a temperature of the high speed carrier gas is lower than a decomposition temperature of nitride when the rare earth magnet powder includes a nitride.

11. The method for producing a thick magnet film according to claim 5, wherein an inert gas is used as the carrier gas.

12. A magnet motor being obtained by using the thick magnet film described in claim 1.
